(19) United States
(12) Patent Application Publication
(10) Pub. No.: US 2006/0004815 A1
(43) Pub. Date: Jan. 5, 2006

(54) Method and apparatus for editing metadata, and computer product

(75) Inventors: Miho Murata, Kawasaki (JP); Yasuhiko Kanemasa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/997,042

(22) Filed: Nov. 24, 2004

(30) Foreign Application Priority Data
Jul. 1, 2004 (JP) 2004-196043

(51) Int. Cl. G06F 17/00

(52) U.S. Cl. 707/101

(57) ABSTRACT

A method for editing metadata that is used for integration of data in a database-integration reference apparatus that refers to data distributed in a plurality of databases virtually as data in a single integrated database includes displaying a schema of the databases, the schema being formed with a plurality of elements; editing the metadata based on an element that is selected by a creator of the metadata from among the elements in the schema, where the element is arranged in a tree structure; and transmitting the metadata edited to the database-integration reference apparatus.

### BACKGROUND OF THE INVENTION

1) Field of the Invention

The present invention relates to a method, an apparatus, a computer product, and a recording medium for editing metadata that is used for integrating data in an integrated database reference apparatus.

2) Description of the Related Art

When relevant data scattered on a plurality of databases and it is desired to refer to the data collectively, database integration by distributed query has been recently promoted, in which these databases are respectively referred and the results thereof are synthesized, so that it appears as if one database is being referred.

Such database integration by distributed query has an advantage in that the data can be referred on real time bases, since the respective databases are referred when a person referring to the data (hereinafter, “data referring person”) requests data, to obtain the result.

In the case of database integration by distributed query, there is a method of providing a view in the form of a tagged document, to the data referring person, so that it appears as if one database is being referred. In order to provide the view in the form of a tagged document, it is necessary to prepare in advance metadata for defining the view.

For example, in the integrated database reference apparatus disclosed in Japanese Patent Application No. 2004-012306, an Extensible Markup Language (XML) view is provided to a data referring person, and when the person inputs a query by using XQuery, being a query language to the XML, the query result is returned in the XML Format. In this integrated database reference apparatus, an integration rule is described in the metadata in the XML format, in order to define the XML view.

In Non-Patent Literature 1 (IBM Almaden Research Center “Querying XML Views of Relational Data”, [online] [Searched on 10th Jun. 2004] the Internet <http://www.almaden.ibm.com/software/dm/Xperanto/Xperanto.2001.pdf>), a default XML view in which the schema of the respective databases to be integrated is directly reflected is provided, and metadata is described by using the XQuery, in order to define the XML view peculiar to a user.

Thus, distribution of data can be hidden by describing the integration rule in the metadata defining the view in the form of the tagged document.

However, since editing of the metadata defining the view in the form of the tagged document (hereinafter, “integration metadata”) has been conventionally performed manually, there is a problem in that a long time and extra labor are required. In other words, since it is necessary to describe information of the databases to be integrated in the integration metadata, a creator of integration metadata should be familiar with the schema of the respective database.

Further, the creator of integration metadata individually collects the meta-information of the respective databases, but since the creator handles a plurality of databases, the meta-information may be scattered, or the format may not be unified, and hence, it takes time and labor to obtain the information of all databases. Along with a possibility of writing mistakes in the manual editing, when the description of the integration metadata is incorrect, query thereto is not possible.

Further, since a plurality of databases is to be handled, it is necessary to define in the integration metadata the elements in the respective databases to be associated with each other. For this purpose, it is necessary to understand the schema of the respective databases to which the respective elements belong, collect the information such as column names and data type of the both elements, and put various types of information together to make a decision whether certain elements can be associated with each other.

However, a wrong decision may be made only by the above information, and when the decision is wrong, there will be no data corresponding to the query condition, thereby making the integration metadata meaningless. Therefore, when the elements to be associated with each other are defined, it is necessary to define these carefully.

When the number of databases to be integrated increases, it becomes more difficult to find consistency between the schema of the respective databases and the integration metadata, as well as consistency within the integration metadata. When contents of the database are changed, it is necessary to correct the integration metadata, and if there is an omission in the correction, the degree of consistency between these cannot be maintained.

Further, when a plurality of databases is integrated so that the database is referred from a plurality of departments, the view in the form of tagged document different for each department may be prepared. In this case, since there may be data that should not be seen by persons at other departments, there is a demand to restrict data referring persons who can use the data for each view. Conventionally, however, there is a problem in that all prepared views are seen by all data referring persons.

### SUMMARY OF THE INVENTION

It is an object of the present invention to solve at least the above problems in the conventional technology.

A computer-readable recording medium that stores a computer program for editing metadata that is used for integration of data in a database-integration reference apparatus that refers to data distributed in a plurality of databases virtually as data in a single integrated database according to one aspect of the present invention makes a computer execute displaying a schema of the databases, the schema being formed with a plurality of elements; editing the metadata based on an element that is selected by a creator of the metadata from among the elements in the schema, and that is arranged in a tree structure; and transmitting the metadata edited to the database-integration reference apparatus.

A method for editing metadata that is used for integration of data in a database-integration reference apparatus that refers to data distributed in a plurality of databases virtually as data in a single integrated database according to still another aspect of the present invention includes displaying a schema of the databases, the schema being formed with a plurality of elements; editing the metadata based on an element that is selected by a creator of the metadata from among the elements in the schema, and that is arranged in a tree structure; and transmitting the metadata edited to the database-integration reference apparatus.

An apparatus for editing metadata that is used for integration of data in a database-integration reference apparatus that refers to data distributed in a plurality of databases virtually as data in a single integrated database includes a display unit that displays a schema of the databases, the schema being formed with a plurality of elements; an editing unit that edits the metadata based on an element that is selected by a creator of the metadata from among the elements in the schema, and that is arranged in a tree structure; and a transmitting unit that transmits the metadata edited to the database-integration reference apparatus.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of a screen provided by a metadata editor according to one embodiment of the present invention;

FIG. 2 is a block diagram of a configuration of a metadata editing system according to the embodiment;

FIG. 3 is a schematic diagram of a relation between a schema displayed on a database (DB)-information panel screen and database list information;

FIG. 4 is a schematic diagram of a relation between a tree structure and an XML view;

FIG. 5 is a schematic diagram of data schema collection by a GRID general account;

FIG. 6 is a schematic diagram of data schema collection by an individually designated account;

FIG. 7 is a schematic diagram of database list information available to user1 account;

FIG. 8 is a schematic diagram of database list information available to user3 account;

FIG. 9 is a schematic diagram for explaining an outline for creating a tree structure;

FIG. 10 is a schematic diagram of a procedure for creating the tree structure;

FIG. 11 is a schematic diagram of the procedure for creating the tree structure;

FIG. 12 is a schematic diagram of the procedure for creating the tree structure;

FIG. 13 is a schematic diagram of the procedure for creating the tree structure;

FIG. 14 is a schematic diagram of a column element including a plurality of data;

FIG. 15 is a schematic diagram of a definition example of the tree structure by XML;

FIG. 16 is a schematic diagram of an example of schema/database correspondence information by XML;

FIG. 17 is a schematic diagram of another example of schema/database correspondence information by XML;

FIG. 18 is an example of association information between elements by XML;

FIG. 19 is a schematic diagram of an association procedure;

FIG. 20 is a schematic diagram of the association procedure;

FIG. 21 is a schematic diagram of the association procedure;

FIGS. 22A and 22B are a flowchart of an association processing by an associating unit;

FIG. 23 is a flowchart of an existing association information query routine;

FIG. 24 is a schematic diagram of an association check processing;

FIG. 25 is a schematic diagram of association checking;

FIG. 26 is a schematic diagram of the association checking;

FIG. 27A is a schematic diagram of the association checking;

FIG. 27B is a schematic diagram of the association checking;

FIG. 28 is a schematic diagram of the association checking;

FIG. 29 is a schematic diagram of the association checking;

FIG. 30 is a flowchart of an association check processing by an association checking unit;

FIG. 31 is a schematic diagram of a consistency check of integration metadata by a consistency checking unit;

FIG. 32 is a schematic diagram of a computer system that executes the metadata editor according to the embodiment; and

FIG. 33 is a block diagram of a configuration of a main unit shown in FIG. 32.

### DETAILED DESCRIPTION

Exemplary embodiments of a method and apparatus for editing metadata, and a computer program and a recording medium therefor, according to the present invention will be explained in detail with reference to the accompanying drawings. In the embodiments, an example in which the invention is applied to a relational database (RDB) will be explained. Further, XML is adopted for a tagged document.

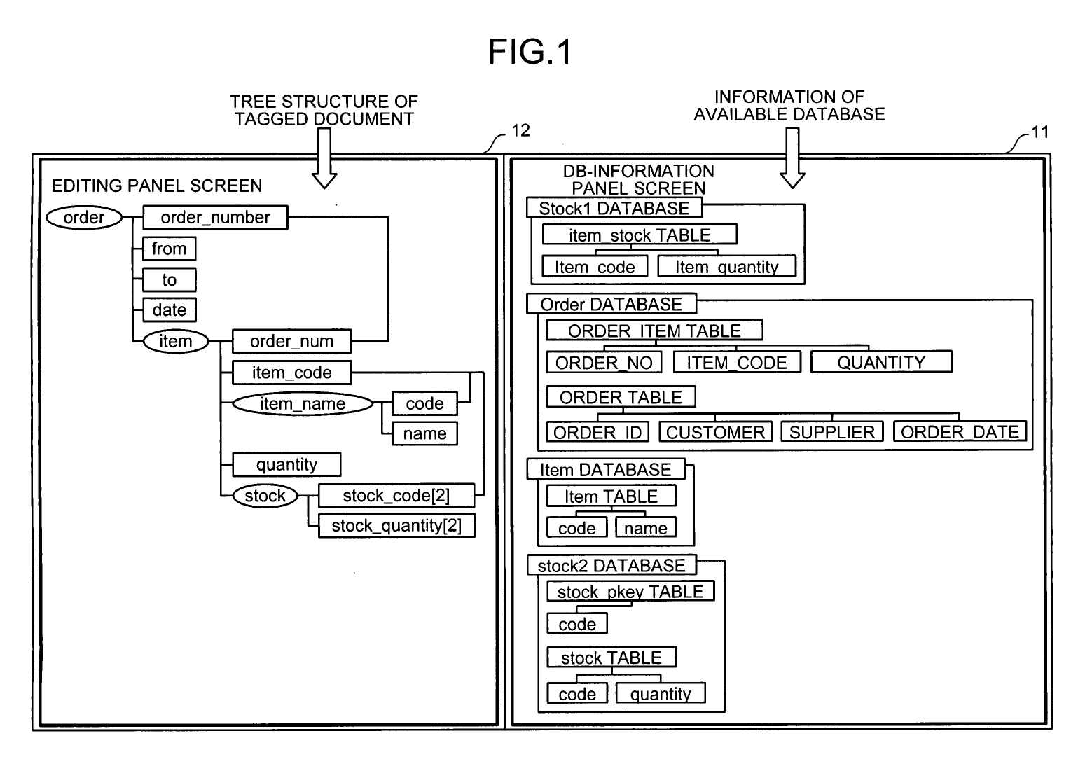

At first, a screen provided by a metadata editor according to the embodiment will be explained. FIG. 1 is one example of the screen provided by the metadata editor according to the embodiment. The metadata editor provides a DB-information panel screen 11 for obtaining location and meta-information of an available database to display the schema thereof, and an editing panel screen 12 for displaying a tree structure for defining a view in the form of a tagged document.

The creator of integration metadata only needs to select necessary elements from the schema of the respective databases displayed on the DB-information panel screen 11, and drag and drop the elements into the tree structure in the XML view on the editing panel screen 12. Elements here refer to columns in the relational database.

When the necessary elements are dragged and dropped in the tree structure, the metadata editor according to the embodiment arranges the elements in the tree structure according to a description rule for the integration metadata. When the elements are arranged in the tree structure, the information of the database to which the element belongs is stored as the element information of the tree structure.

Thus, the metadata editor according to the embodiment automatically creates the integration metadata, when the creator of integration metadata selects the necessary elements from the schema displayed on the DB-information panel screen 11, and drags and drops the elements into the tree structure of the tagged document on the editing panel screen 12. Therefore, the creator of integration metadata can create the integration metadata efficiently, without the need of collecting the meta-information of the respective databases.

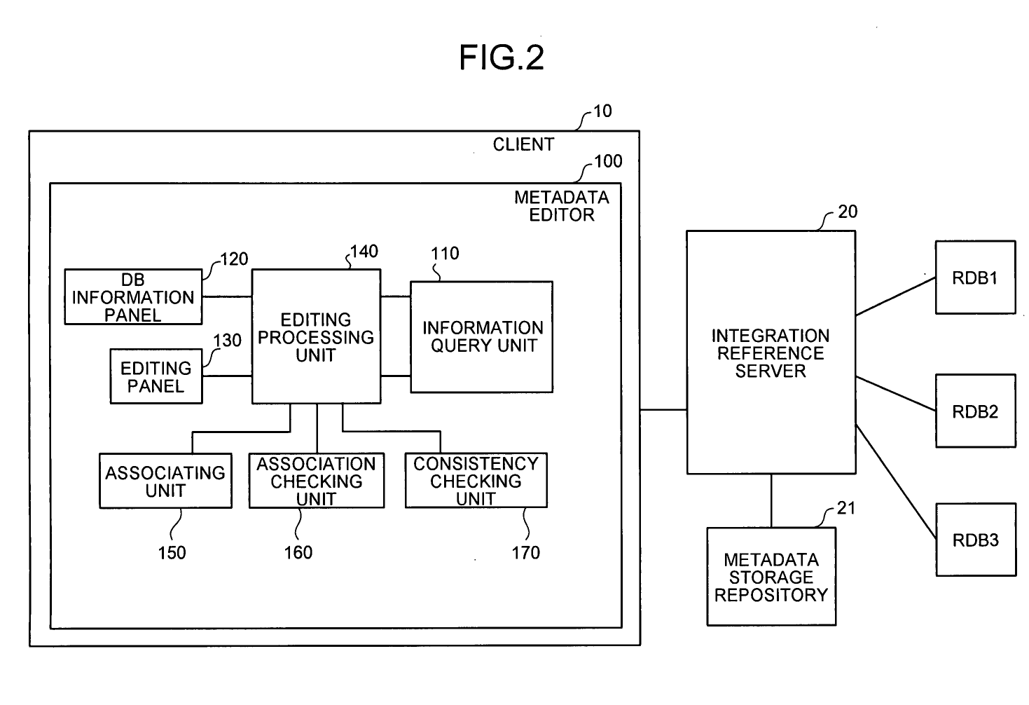

The system configuration of the metadata editing system according to the embodiment will be explained. FIG. 2 is a functional block diagram of the system configuration of the metadata editing system according to the embodiment. The metadata editing system is formed by connecting a client 10 in which the metadata editor 100 operates, and an integration reference server 20 that stores the integration metadata in a metadata storage repository 21, to perform database integration by distributed query by using the stored integration metadata via a network. For the convenience of explanation, only one client is shown here, but the metadata editing system is formed of a plurality of clients.

The integration reference server 20 has a function of reading the integration metadata from the metadata storage repository 21 in response to a request from the metadata editor 100, and storing the integration metadata in the metadata storage repository 21. Further, the integration reference server 20 collects schema information from databases [RDB1] to [RDB3] to be integrated, and transmits information requested by the metadata editor 100 to the client 10.

While three databases [RDB1] to [RDB3] are shown here as the databases to be integrated, the metadata editing system can edit the integration metadata obtained by integrating an optional number of databases.

The metadata editor 100 has an information query unit 110, a DB information panel 120, an editing panel 130, an editing processor 140, an associating unit 150, an association checking unit 160, and a consistency checking unit 170.

The information query unit 110 is a processor that obtains information of the schema displayed on the DB-information panel screen 11, and information of the integration metadata edited on the editing panel screen 12 from the integration reference server 20. The information query unit 110 also transmits the information relating to the edited integration metadata to the integration reference server 20.

The DB information panel 120 is a panel for storing the information of the schema obtained by the information query unit 110 from the integration reference server 20, and displays the schema on the DB-information panel screen 11. In other words, the DB information panel 120 displays available database names, table names, and column names on the DB-information panel screen 11.

Further, the DB information panel 120 displays only the information of available data. That is, when requesting information of the schema to the integration reference server 20, the DB information panel 120 also transmits the account information of the creator of integration metadata. The integration reference server 20 then returns the information of database accessible by the account as database list information.

The DB information panel 120 checks an availability flag with respect to all databases, tables and columns in the returned information, and displays only the available data on the screen. At this time, the structure of the RDB to be integrated is directly displayed.

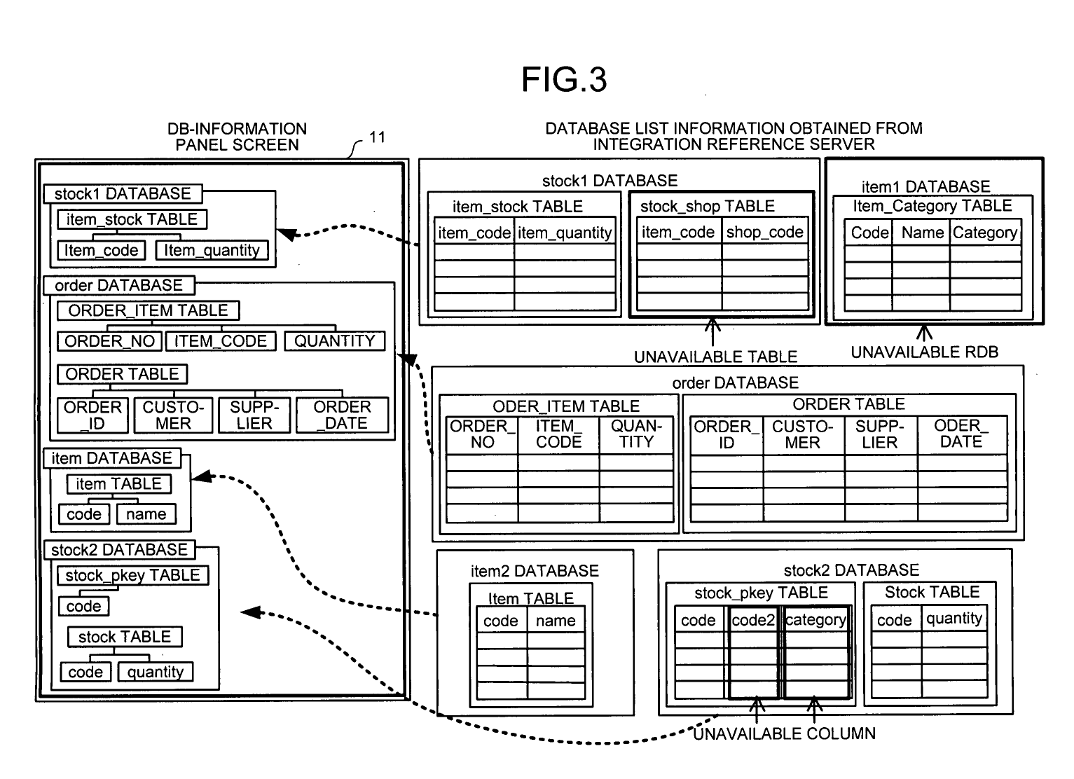

FIG. 3 is a diagram for explaining the relation between the schema displayed on the DB-information panel screen 11 and the database list information. The database list information obtained from the integration reference server 20 includes information of unavailable databases, tables, and columns. The unavailable databases, tables, and columns here are those being unavailable as a result of deletion of a database, table, or column, which has been present before, or a name change.

The DB information panel 120 displays the schema of the database on the DB-information panel screen 11, excluding these unavailable data included in the database list information obtained from the integration reference server 20.

The editing panel 130 is a panel for storing information relating to the integration metadata, and displaying the tree structure of the XML view on the editing panel screen 12. The editing panel 130 stores, as the integration metadata, virtual XML schema information, schema/database correspondence information, and association information between elements.

The virtual XML schema information is information for defining the tree structure of the XML view. The virtual XML schema information defines in what structure the data existing in a plurality of databases is to be shown to the data referring person. The editing panel 130 displays the tree structure on the editing panel screen 12 based on this information.

The schema/database correspondence information defines the correspondence between the respective elements in the tree structure and the elements in the database. The editing panel 130 holds this information while the integration metadata is being edited, and updates the information every time the tree structure is created or changed.

The association information between elements defines the correspondence between the elements in the respective tables, when elements in the databases are to be associated with each other to form one tagged document. The editing panel 130 holds this information while the integration metadata is being edited, and updates the information every time the tree structure is created or changed.

When the editing panel 130 requests the integration metadata to the integration reference server 20, the integration reference server 20 extracts the information of the relevant integration metadata from the metadata storage repository 21 and sends it back.

Upon reception of the information of integration metadata, the editing panel 130 extracts the portion of the virtual XML schema information defining the tree structure of the XML view from the information, and displays the tree structure on the screen. At this time, the arranged positions of the constituents constituting the tree structure directly reflect the hierarchical structure of the tree structure.

The tree structure displayed by the editing panel 130 does not completely match with the structure of the XML view shown to the data referring person. It is because the tree structure also includes elements that are necessary for assembling the tree structure, but need not be shown as the XML view to the data referring person.

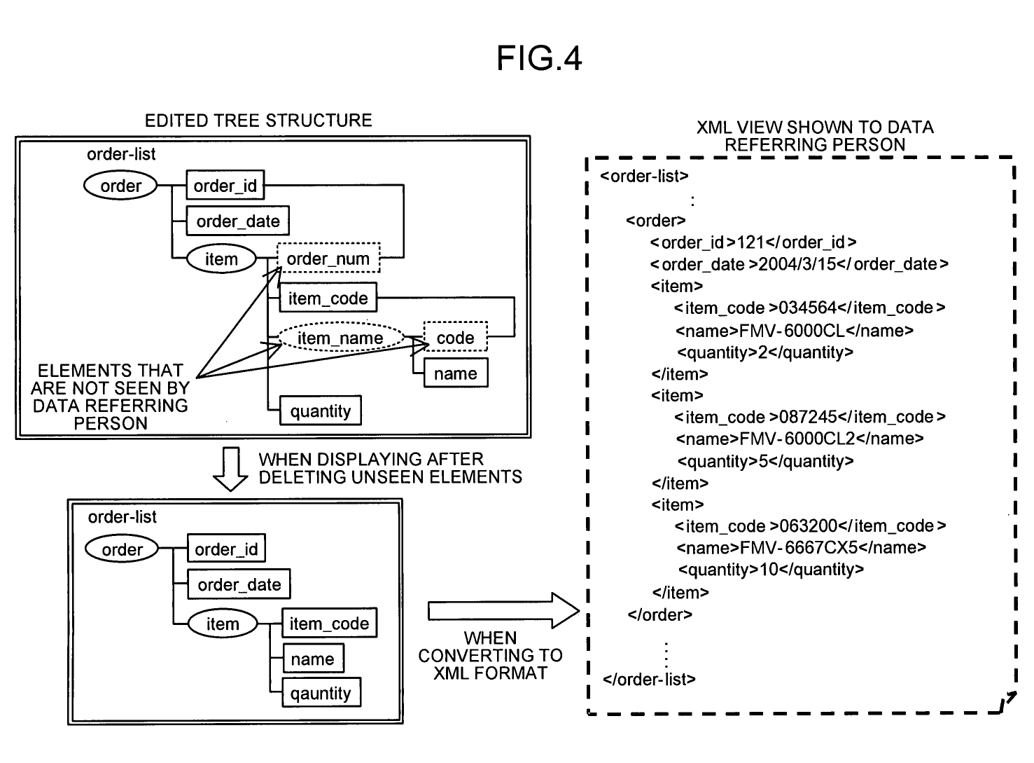

FIG. 4 is one example of the relation between the tree structure and the XML view. In FIG. 4, “order_num” is a column associated with “order_id”, and “code” is a column associated with “item_code”.

Therefore, “order_num” and “code” are elements that need not be shown to the data referring person, if “order_id” and “item_code” are displayed. By setting these elements as ones that need not be shown to the data referring person, these elements can be deleted from the tree structure for display. The details of association between elements will be described later.

The editing panel 130 can display the tree structure defined by the same integration metadata in an edited form, or can show the tree structure, deleting the elements that are not shown to the data referring person. The latter structure matches with the structure of the XML view to be shown to the data referring person.

The editing processor 140 is a processor that edits the integration metadata. In other words, the editing processor 140 accepts the drag and drop operation by the creator of integration metadata, and edits the virtual XML schema information, the schema/database correspondence information, and the association information between elements stored in the editing panel 130.

The associating unit 150 is a processor that displays element combinations in which association between elements in different tables is possible, when an element in a table different from the already arranged element is dragged and dropped, and associates the elements specified by the creator of integration metadata based on the displayed element combination. The details of the associating unit 150 will be described later.

The association checking unit 160 is a processor that statistically determines the validity of the element combination specified by the creator of integration metadata. The details of the association checking unit 160 will be described later.

The consistency checking unit 170 is a processor that checks whether the integration metadata edited in the past uses an unavailable database, table or column, resulting from a change in the schema of the database. The details of the consistency checking unit 170 will be described later.

The access control in the metadata editing system according to the embodiment will be explained. In the database integration by the distributed query, there is a demand to restrict the data referring persons who can use the XML view defined by certain integration metadata.

It is easy to realize this, that is, it is only necessary to set the access right to the integration metadata, and confirm the access right of the data referring person at the time of handling the query. However, with this method, there is the following problem.

That is, when it is failed to create the integration metadata or set the access right, data that is not supposed to be seen are referred. Further, to avoid this, much attention is needed, thereby requiring extra labor to create the integration metadata.

Further, the creator of integration metadata can see all database schema that can be handled by the system, and can set the access right thereto. This means that there is a user who has the authority accessible to much data outside the system, as seen from the standpoint of the individual database, thereby making the security management too permissive. For example, if there is one malicious creator of integration metadata, data that is not supposed to be seen may be referred.

In the metadata editing system according to the embodiment, therefore, these problems are solved by restricting the database information (database name, table name, and column name) to be displayed on the DB-information panel screen 11, at the time of creating the integration metadata, to the one corresponding to the access right of the creator of integration metadata. The procedure for this is as follows.

At first, an account setting file is prepared. In this account setting file, an account name transmitted from the metadata editor 100, the database name, and the DB account name to be used by the account at the time of referring to the database are described. Only the manager of the whole integration reference server 20 holds the authority to edit the account setting file, and hence the creator of integration metadata cannot edit the file.

A DB monitoring daemon in the integration reference server 20 accesses all databases at a certain interval at all times, to obtain the data schema information (all the table names and column names) at that time, and manages the information as the database list information.

At this time, the data schema information is normally obtained by a grid general account, “grid_anonymous”, but when there is the description in the account setting file, the data schema information is also obtained by the described account with respect to the described database. The obtained data scheme information is managed as the data schema, the reference to which is allowed only to the account, separately from the one obtained by “grid_anonymous”.

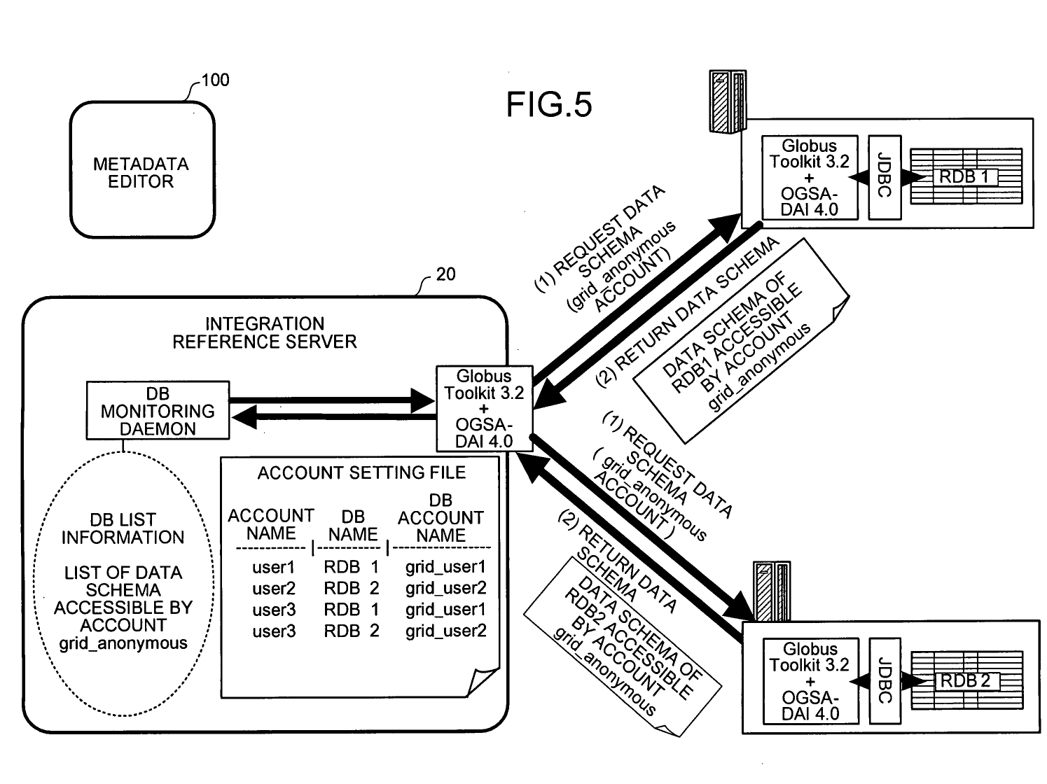

FIG. 5 depicts data schema collection by the GRID general account. The DB monitoring daemon in the integration reference server 20 accesses, for example, “RDB1” and “RDB2” regularly by the “grid_anonymous” account, to obtain the data schema information at that time, and manages the information as a data schema list that can be accessed by the “grid_anonymous”. “Globus Toolkit 3.2+OGSA-DAI4.0”, being conventional query-based database integration, is directly used for the access to the database.

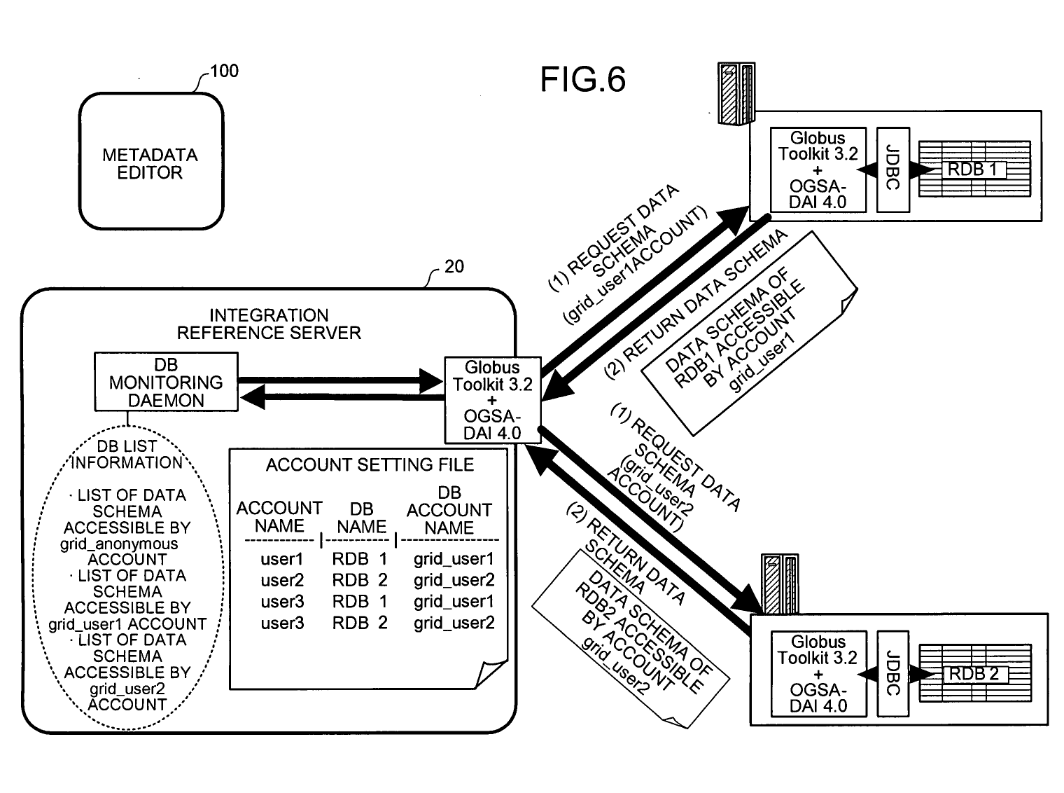

FIG. 6 depicts data schema collection by an individually designated account. As shown in FIG. 6, since there are two DB account names, “grid_user1” and “grid_user2” in the account setting file held by the integration reference server 20, at the time of data schema collection by the GRID general account shown in FIG. 5, these accounts access the “RDB1” and “RDB2” that can be accessed by these accounts respectively, to obtain the data schema information, and manage the information respectively as the data schema list that can be accessed by “grid_user1” and “grid_user2”.

When the creator of integration metadata logs in the metadata editor 100, the metadata editor 100 requests the database list information managed by the DB monitoring daemon to the integration reference server 20. At the same time, the metadata editor 100 sends the information of the logged in account to the integration reference server 20, and the integration reference server 20 refers to the account setting file and returns only the database list information corresponding to the account. When there is no description in the account setting file, it is regarded that the GRID general account “grid_anonymous” is designated.

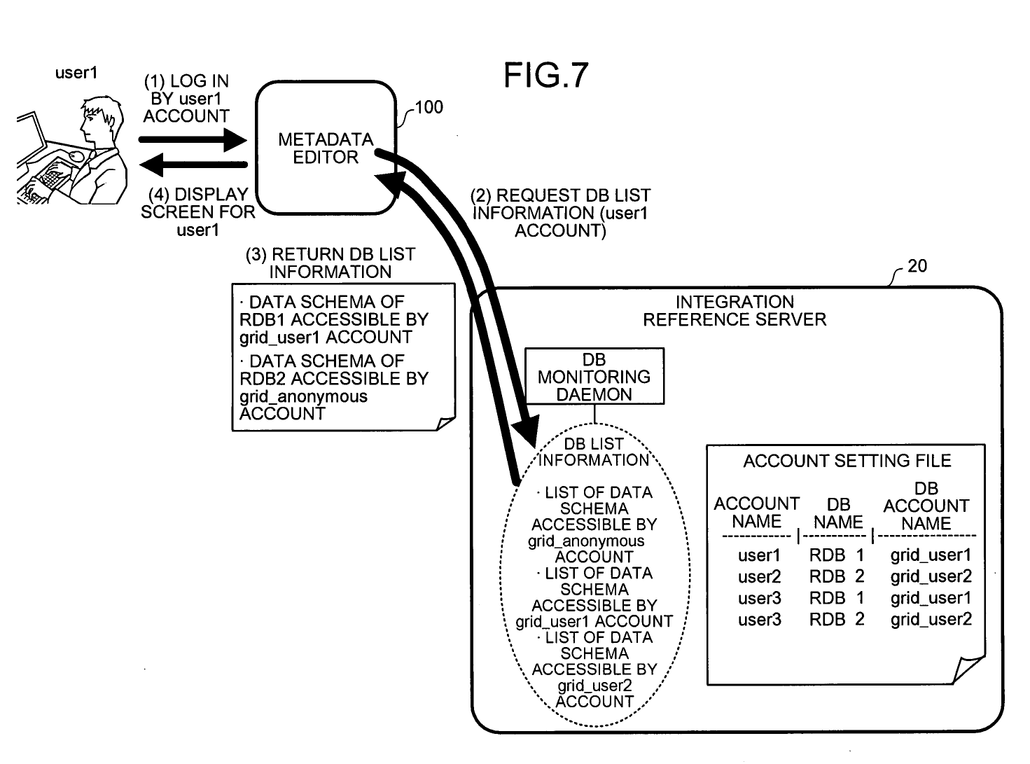

FIG. 7 depicts the database list information available to user1 account. As shown in FIG. 7, when the metadata editor 100 is logged in by the user1 account, the integration reference server 20 returns to the metadata editor 100 the data schema list that can be accessed by the corresponding DB account “grid_user1” with respect to the “RDB1” described in the account setting file, and the data schema list that can be accessed by “grid_anonymous” with respect to the other databases (here, “RDB2”).

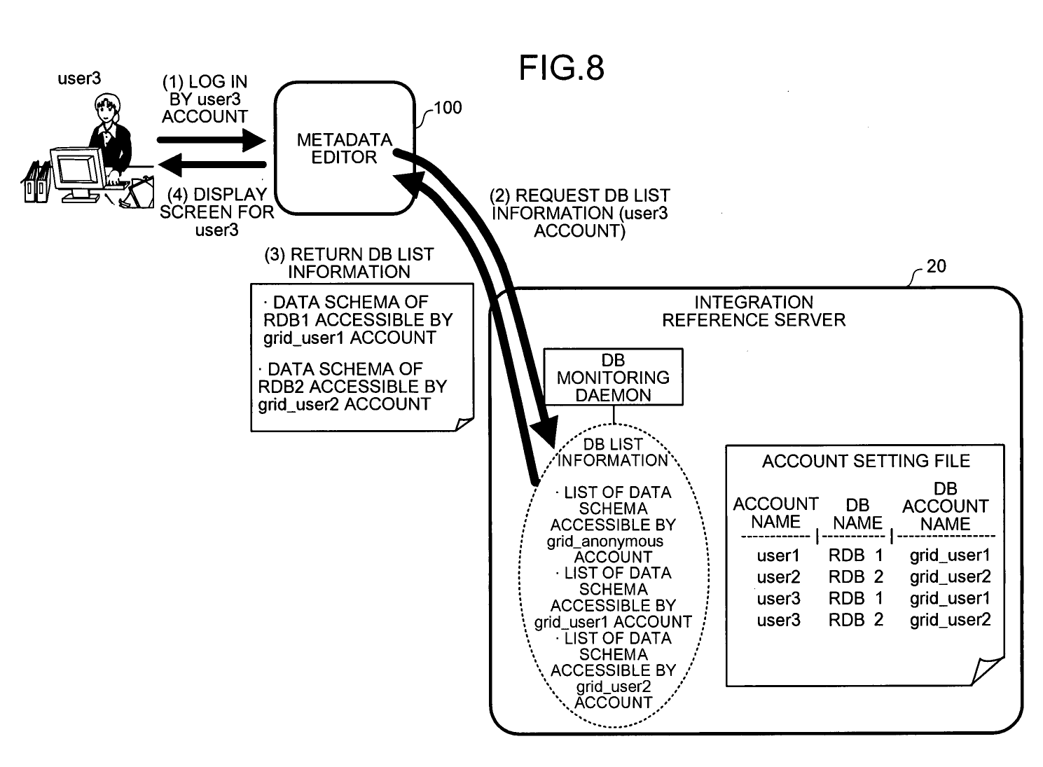

FIG. 8 depicts the database list information available to user3 account. As shown in FIG. 8, when the metadata editor 100 is logged in by the user3 account, the integration reference server 20 returns to the metadata editor 100 the data schema list that can be accessed by the “grid_user1” described in the account setting file with respect to the “RDB1”, and the data schema list that can be accessed by “grid_user2” described in the account setting file with respect to the “RDB2”.

The metadata editor 100 displays the database list information returned by the integration reference server 20 on the DB-information panel screen 11, so that the creator can create the integration metadata by using the information.

Thus, since the integration reference server 20 refers to the account setting file, to return only the database list information corresponding to the account of the creator of integration metadata, the database information to be displayed by the metadata editor 100 can be restricted to the one corresponding to the access right of the creator of integration metadata.

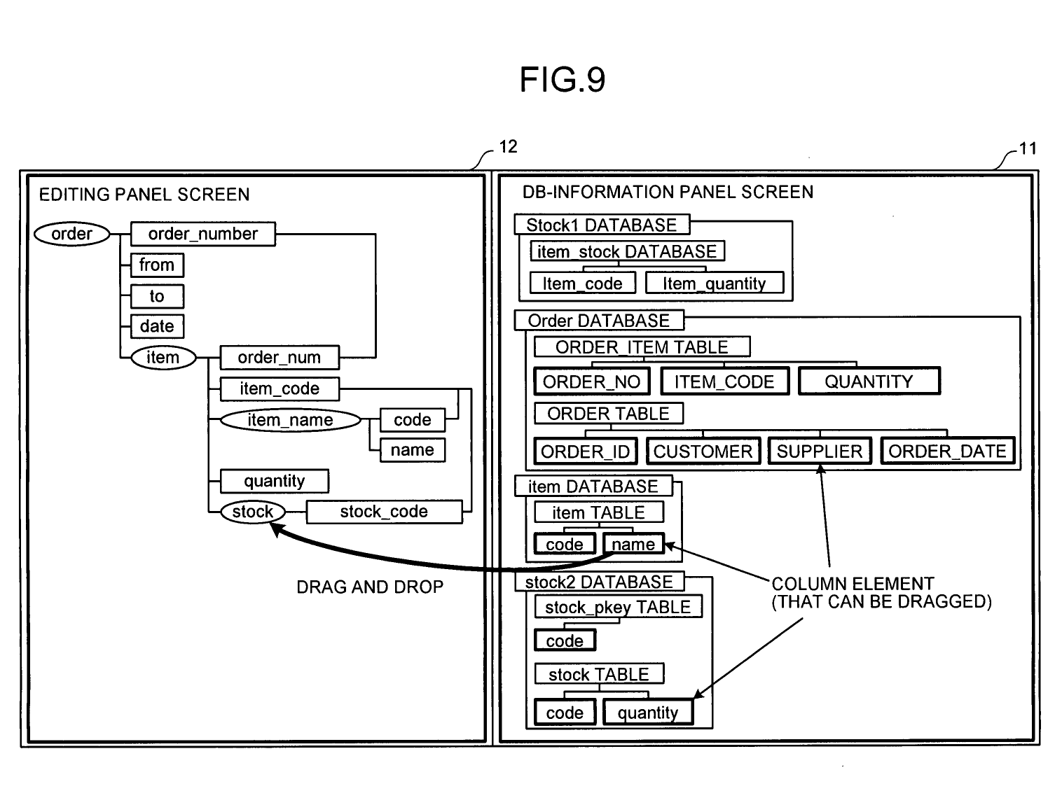

The creation procedure of the integration metadata by the editing processor 140 will be explained below. FIG. 9 is a diagram for explaining the outline for creating a tree structure. As shown in FIG. 9, the creator of integration metadata drags column elements to be included in the tree structure from the DB-information panel screen 11, and drops the column elements on an optional element in the tree structure on the editing panel screen 12, thereby assembling the tree structure.

On the DB-information panel screen 11, only the column elements can be dragged, and the column elements are dropped on the tree structure on the editing panel screen 12. The reason why the element name on the DB-information panel screen 11 does not always match with the element name on the editing panel screen 12 is that the element name on the editing panel screen 12 can be changed.

The editing processor 140 creates the integration metadata in the following procedure, corresponding to the assembly of the tree structure by the creator of integration metadata.

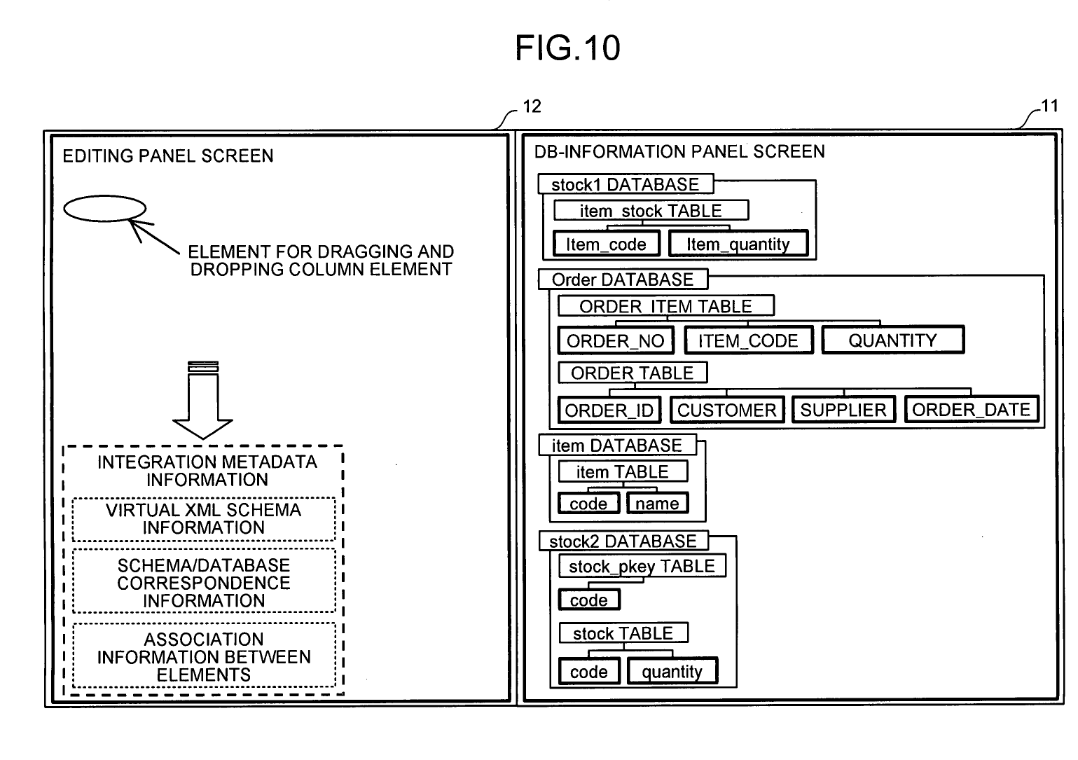

When the creator of integration metadata creates the tree structure for the first time, the editing processor 140 arranges only one element for dragging and dropping the column element on the editing panel screen 12 (FIG. 10).

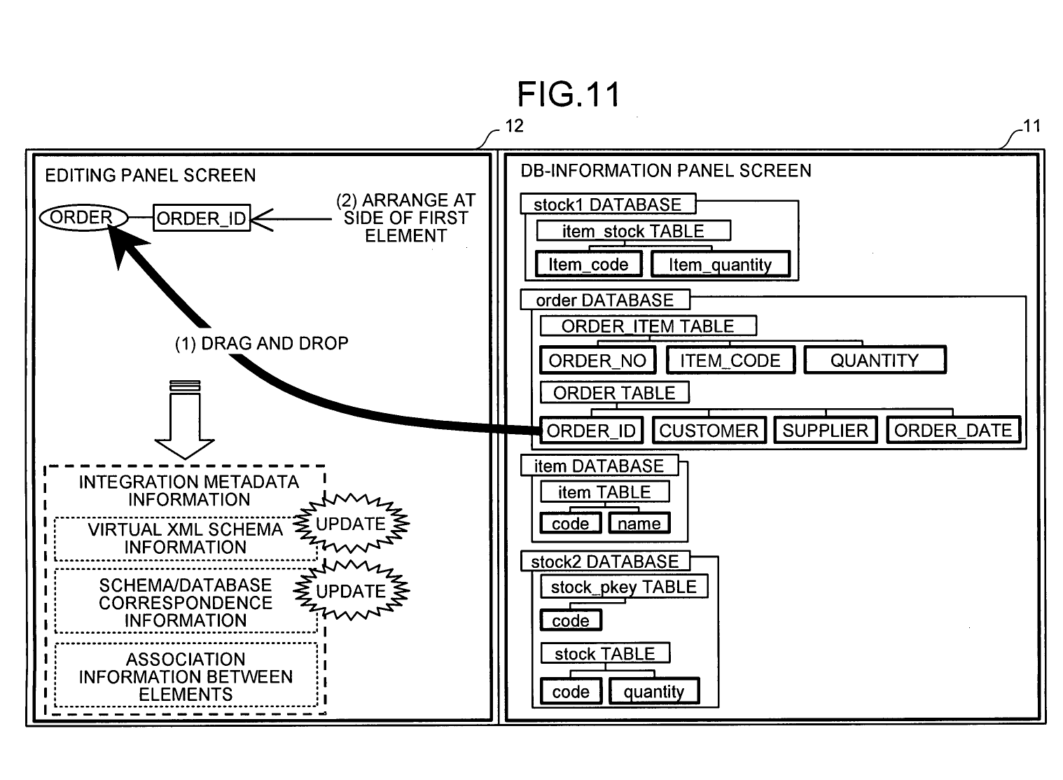

When the creator of integration metadata drags and drops a necessary element on this element from the DB-information panel screen 11 (FIG. 11 (1)), the editing processor 140 arranges the dropped column element at the side of the first element (FIG. 11 (2)).

This corresponds to an addition of a new XML element to a lower hierarchy of a certain XML element. When the column element is added, the editing processor 140 updates the virtual XML schema information in the integration metadata, and adds information indicating the correspondence between the added column and an element in the schema displayed on the DB-information panel screen 11 to the schema/database correspondence information in the integration metadata.

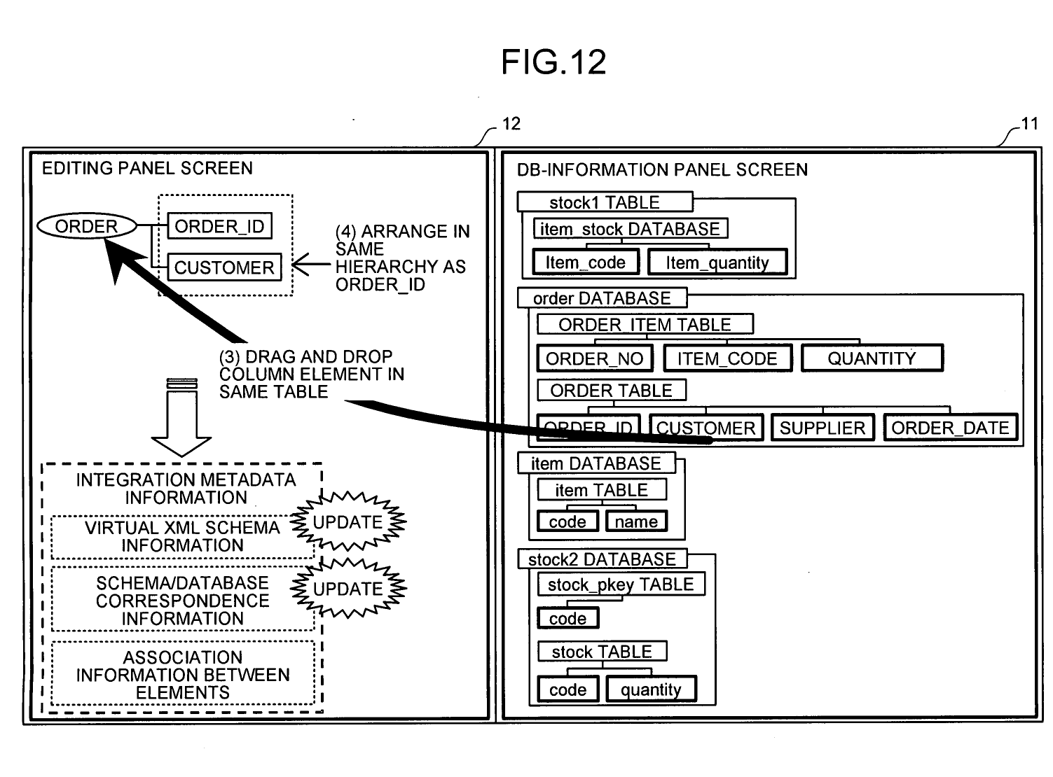

When the creator of integration metadata drags and drops a new column element in the same manner (FIG. 12 (3)), the editing processor 140 checks the table of the already arranged column element and the table of the added column element. As a result, if the both tables are the same, the editing processor 140 arranges the added column element in the same hierarchy as that of the already arranged column element (FIG. 12 (4)).

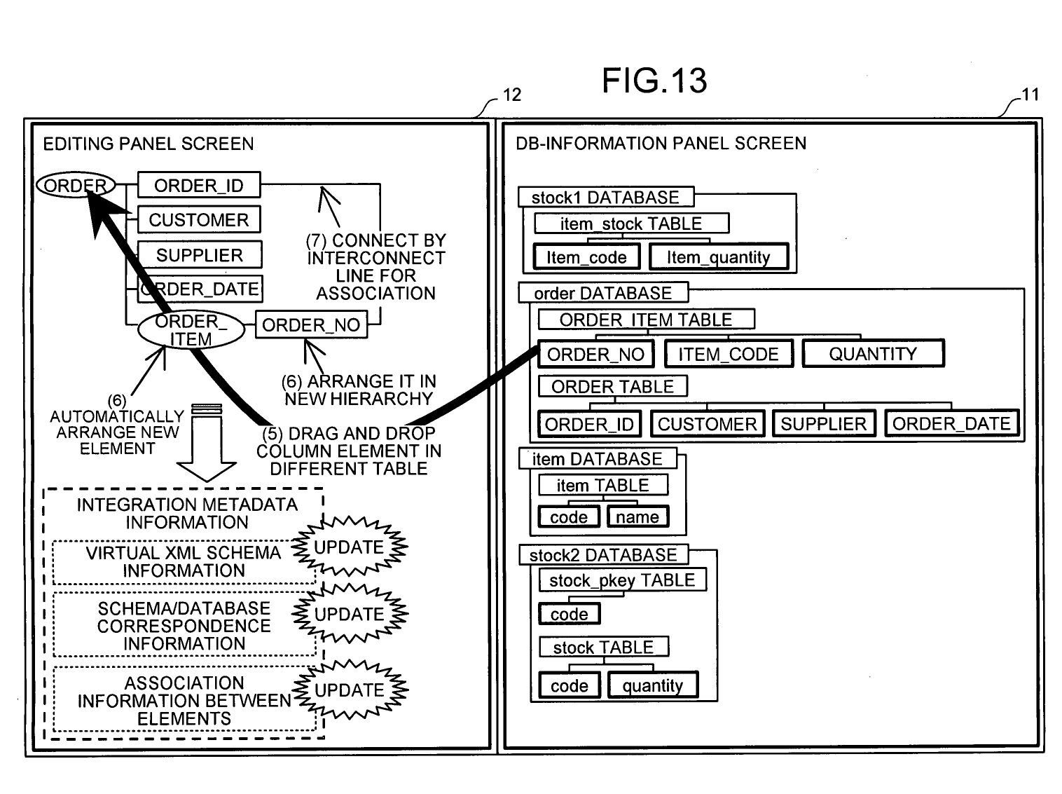

On the other hand, the both tables are different from each other, the editing processor 140 arranges the added column element in a lower hierarchy than that of the already arranged column element (FIG. 13 (5), (6)). This corresponds to an addition of a new XML element in a lower hierarchy of the XML element corresponding to the already arranged column element.

When the creator of integration metadata adds a column element in a table different from the table of the already arranged column element (FIG. 13 (5)), it is necessary to define the association between the elements in the both tables. Therefore, the editing processor 140 lists up combination candidates of elements that can be associated with each other, by using the associating unit 150.

When the creator of integration metadata selects a combination from the listed candidates, the editing processor 140 automatically adds and arranges the necessary column element, and connects the elements by an interconnect line for association ((FIG. 13 (7)). At the same time, the editing processor 140 adds the association information between elements.

When the creator of integration metadata stores the edited integration metadata, the editing processor 140 integrates the virtual XML schema information reflecting the tree structure on the editing panel screen 12, the schema/database correspondence information and the association information between elements updated during editing, and sends the integrated information to the integration reference server 20 via the information query unit 110.

Upon reception of the information, the integration reference server 20 creates an XML file from the information, and stores the file as integration metadata in the metadata storage repository 21. In this embodiment, the information of the integration metadata is converted to the XML file and stored, but the information may be stored not in a file but as an object.

The hierarchical structure of the tree structure assembled in this manner corresponds to the XML hierarchical structure, and each element in the tree structure corresponds to each element in the XML. Generally, one element in the tree structure corresponds to one element in each database. However, when the same type of data is separately stored in a plurality of databases, and it is not clear in which database data having one value is stored, the respective column elements in these databases can be made to correspond to one column element in the tree structure.

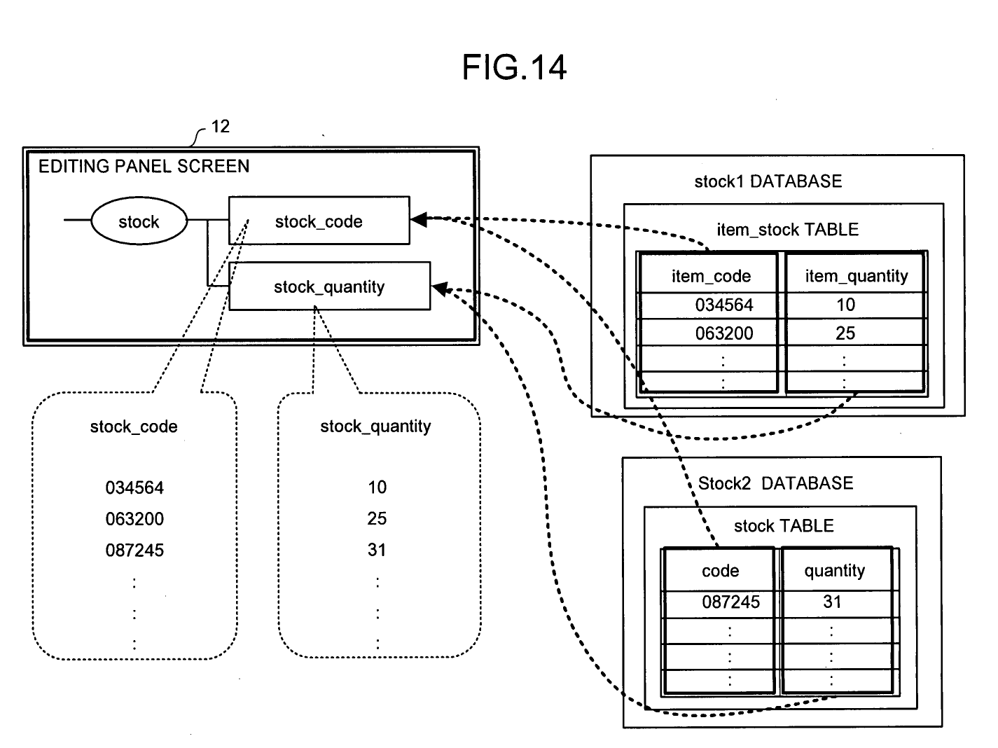

FIG. 14 depicts a column element including a plurality of data. When the stock information of a product having a product code “034564” and a product having a product code “063200” is stored in an item_stock table in a stock1 database, but the stock information of a product having a product code “087245” is stored in a stock table in stock2 database, the column elements “item_code” and “code” of the product code in the both tables can be defined collectively in a stock_code element in the tree structure, and the columns “item_quantity” and “quantity” for inventory quantity in the both tables can be defined collectively in a stock_quantity element in the tree structure.

By having such definition, even if the data referring person does not know in which database a product of a certain product code is present, the integration reference server 20 accesses the both databases of stock1 and stock2, and collects data. In this manner, data stored in separate columns in separate tables appears to the data referring person as if the data is stored in one column.

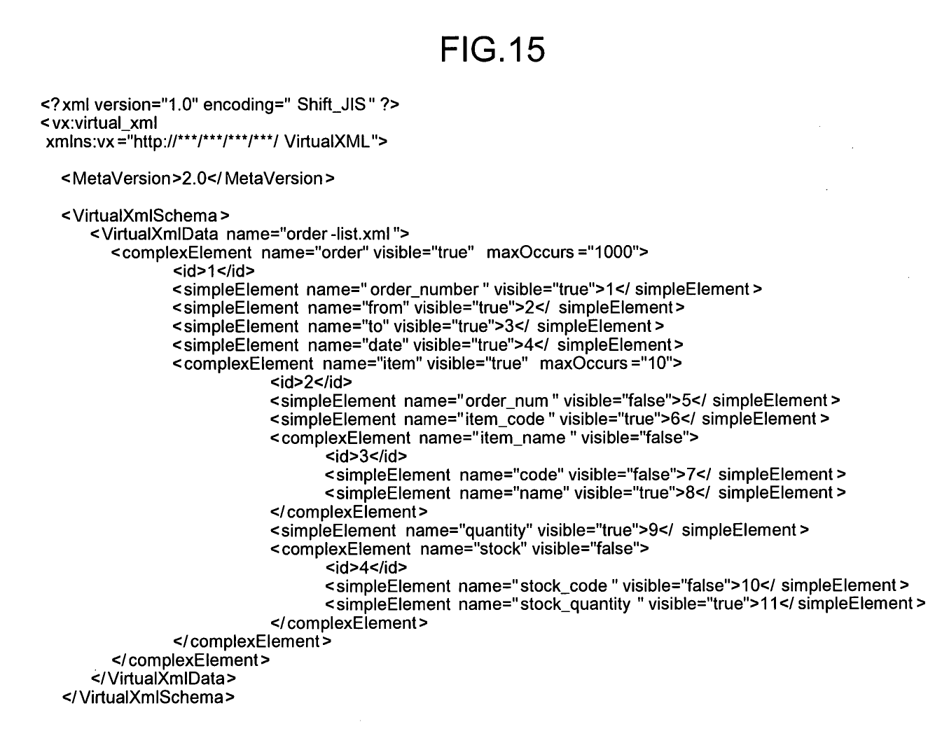

The integration metadata in the XML format generated by the integration reference server 20 will be explained, with reference to FIGS. 15 to 18. FIG. 15 is a definition example of the tree structure by the XML. The definition of the tree structure by the XML is in a form in which the respective elements in the tree structure displayed on the editing panel screen 12 are directly replaced by the XML elements, and an ID is assigned to the respective XML elements.

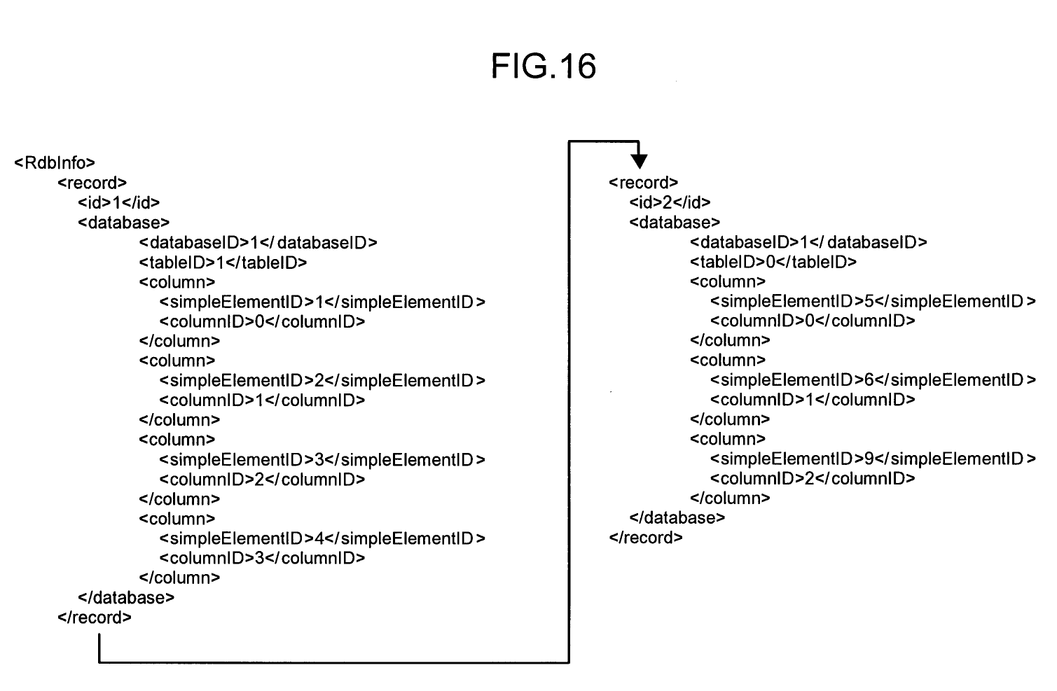

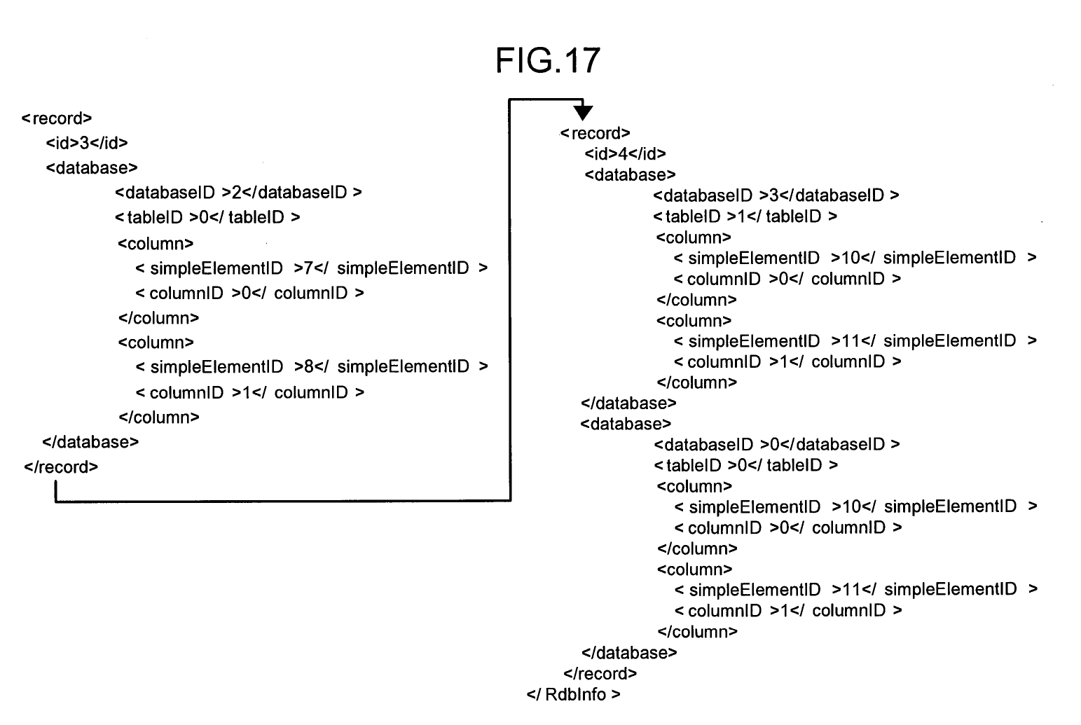

FIGS. 16 and 17 are diagrams (1) and (2) of an example of the schema/database correspondence information by the XML. As shown in FIGS. 16 and 17, the schema/database correspondence information indicates the correspondence between the respective elements in the tree structure and the elements in the respective databases.

The schema/database correspondence information is summarized for each database and table, and the respective databases, tables, and columns are respectively identified by the ID. The correspondence is defined by the column ID and the attached ID of the XML elements in FIG. 15. The actual names and data types of the columns can be known from the database list information obtained from the integration reference server 20 based on the ID.

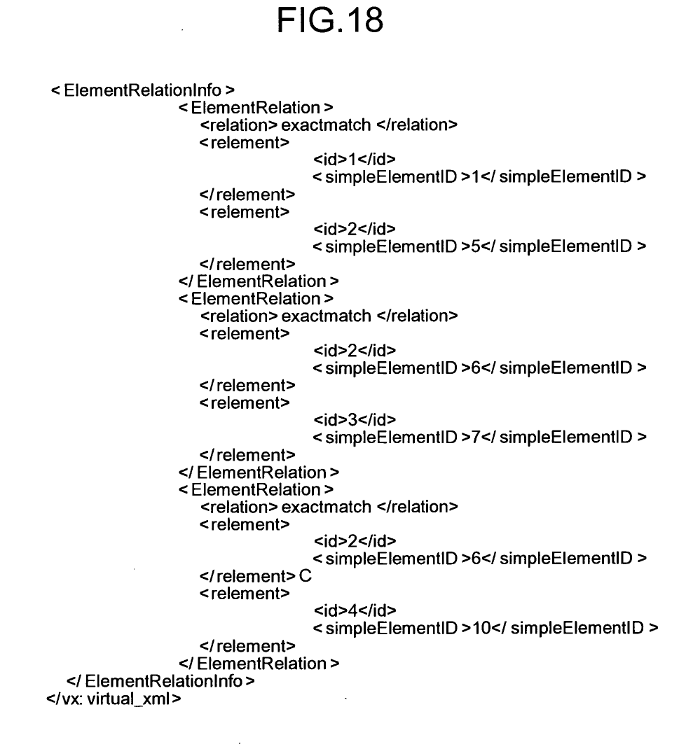

FIG. 18 is an example of the association information between elements by the XML. The association information between elements indicates the association between elements of the different tables, and the correspondence is defined by the IDs of the XML elements.

The details of association between elements by the associating unit 150 will be explained below. When elements in a plurality of tables are associated with each other, the associating unit 150 provides information, which becomes a candidate of association, to the creator of integration metadata, to associate the elements with each other.

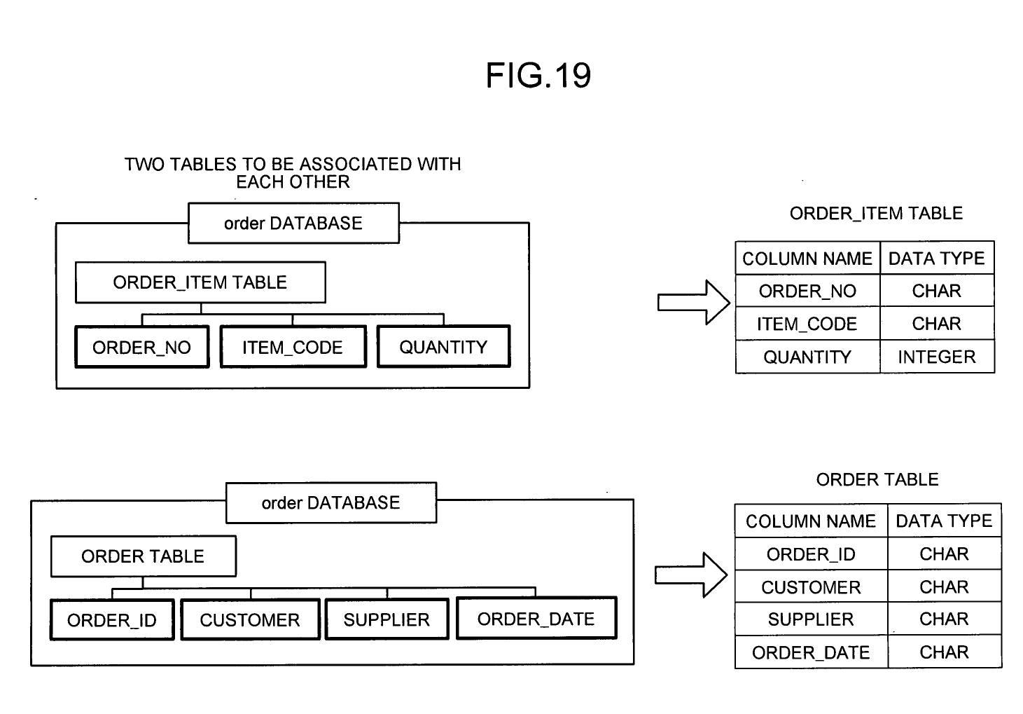

The associating unit 150 first extracts all columns included in the table to which the already arranged column element belongs and the table to which the column element to be added belongs. For example, as shown in FIG. 19, when an ORDER_ITEM table in an order database is to be associated with an ORDER table in the order database, the associating unit 150 extracts the names and data types of all columns in both tables.

The information of the table to which the respective column elements belong, and the information of the columns included in the table are included in the database list information obtained at the time of display on the DB-information panel screen 11.

The data type of all extracted columns is checked. The data type of the column here is included in the database list information obtained at the time of display on the DB-information panel screen 11. From the two column groups, combinations of columns that can be associated with each other are extracted. At this time, the combination capable of association is narrowed down based on the data type of the column.

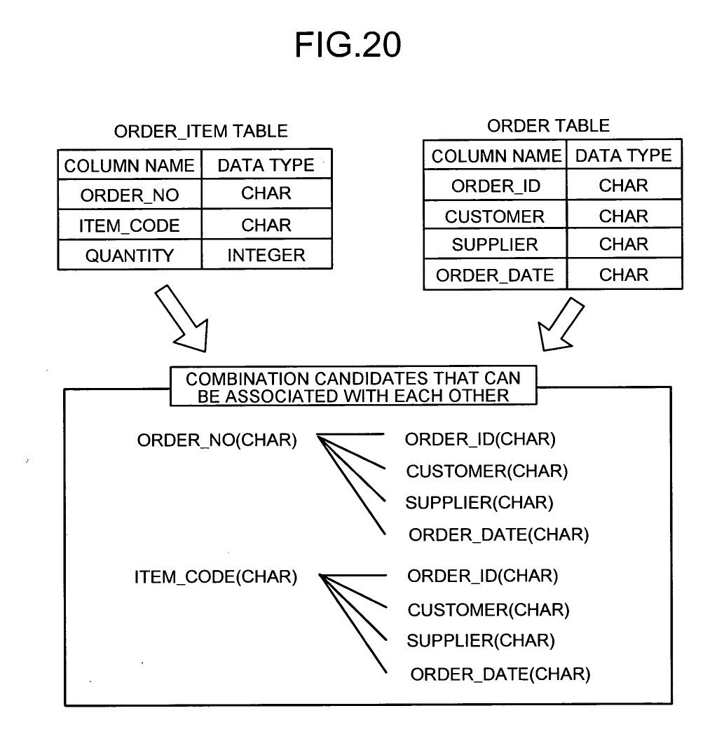

In other words, from the column number “3” in the ORDER_ITEM table and the column number “4” in the ORDER table, there are 12 available combinations of the both columns. However, since only the data type of a column QUANTITY in the ORDER_ITEM table is INTEGER, and is different from the data type CHAR of other columns, the QUANTITY column is excluded from the combination. Therefore, as shown in FIG. 20, there are eight combination candidates of CHAR type columns.

It is then referred to the integration reference server 20 if there is existing association information relating to these columns for the columns included in the combinations, and when the integration reference server 20 returns the existing association information, the information is highlighted to display combinations capable of association, and if there is no existing association information, combinations capable of association are displayed.

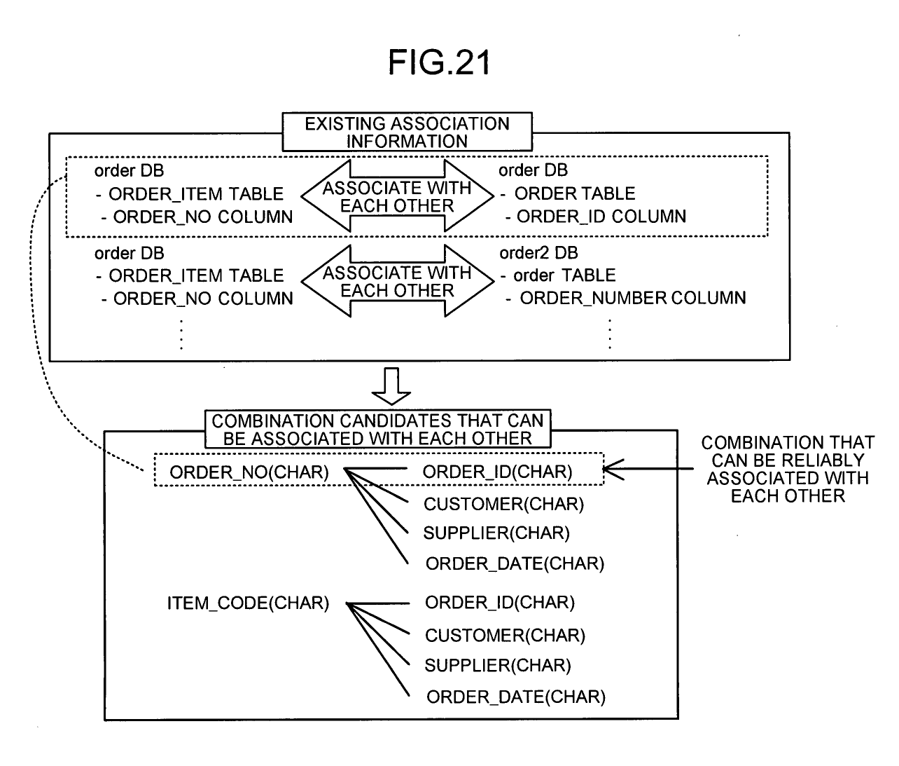

For example, in FIG. 21, there is existing association information with respect to a combination of an ORDER_NO column in the ORDER_ITEM table and an ORDER_ID column in the ORDER table. Therefore, the combination of the ORDER_NO column and the ORDER_ID column is designated as a combination capable of reliable association.

When the creator of integration metadata selects a combination from the displayed candidates, it is checked if the two column elements in the combination have been already arranged on the editing panel screen 12, or if these column elements are the one dragged and dropped by the creator of integration metadata.

As a result, if one of the two column elements has been already arranged on the editing panel screen 12, and the other is a column element dragged and dropped by the creator of integration metadata, the both column elements are connected by an interconnect line for association. On the other hand, any one of the two column elements is not arranged on the editing panel screen 12, nor a column element dragged and dropped by the creator of integration metadata, the column element is automatically added and arranged on the editing panel screen 12 from the DB-information panel screen 11, and the both column elements are connected by an interconnect line for association.

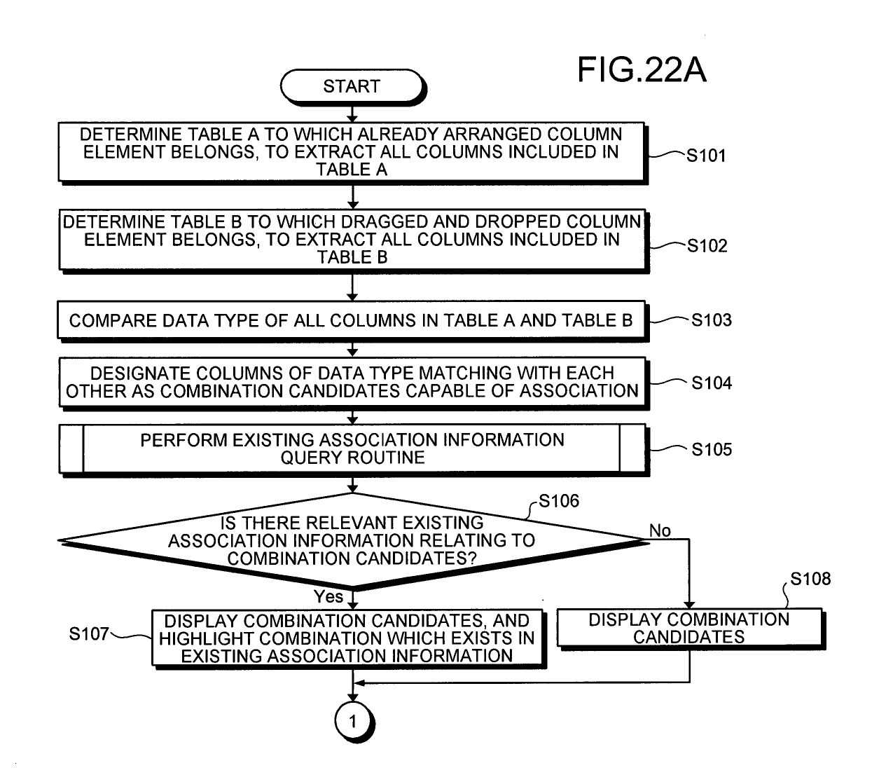

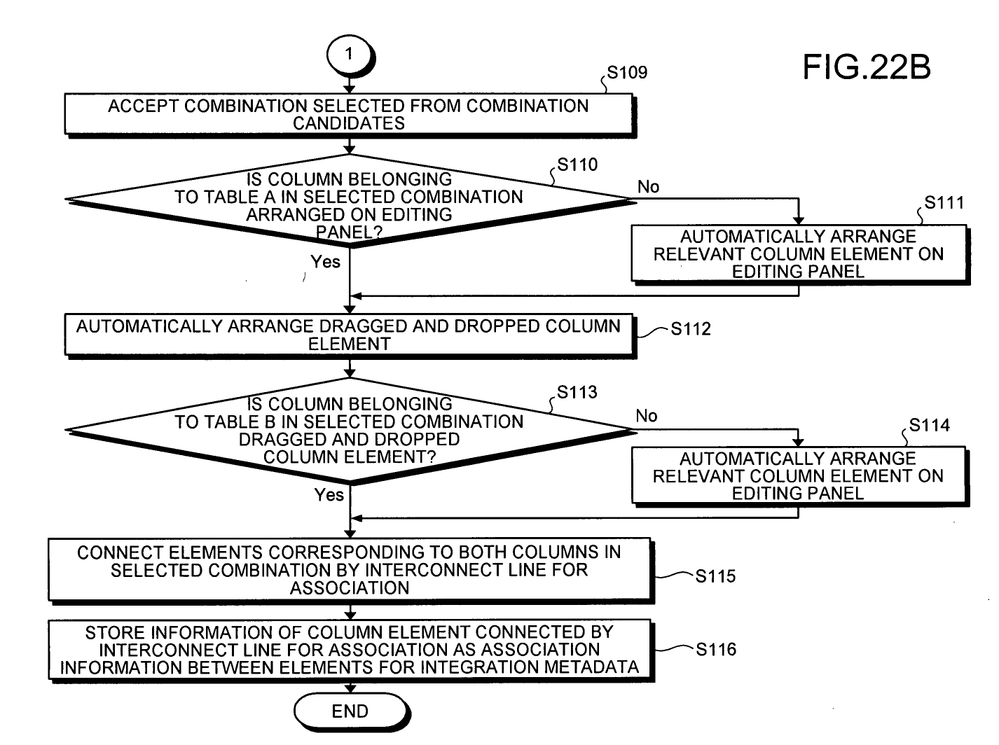

The processing procedure in the association processing by the associating unit 150 will be explained with reference to a flowchart. FIGS. 22A and 22B are a flowchart of the processing procedure in the association processing by the associating unit 150. The association processing is activated when a column element in a table different from the already arranged column element is dragged and dropped on the editing panel screen 12.

In the association processing, determine a table A to which the already arranged column element belongs to extract all columns included in the table A (step S101), and determine a table B to which the dragged and dropped column element belongs to extract all columns included in the table B (step S102).

Subsequently, compare the data type of all columns in the table A and in the table B (step S103), to designate columns of the data type matching with each other as combination candidates capable of association (step S104).

Subsequently, call an existing association information query routine (step S105) to determine whether there is the existing association information in the combination candidates (step S106). As a result, when there is the existing association information in the combination candidates, highlight and display the combination candidates (step S107). When there is no existing association information in the combination candidate, display all combination candidates in the same format (step S108).

Subsequently, accept a combination selected by the creator of integration metadata from the combination candidates (step S109), determine whether the column belonging to the table A in the selected combination is arranged on the editing panel screen 12 (step S110), and when the column is not arranged thereon, automatically arrange the relevant column element (step S111).

Subsequently, automatically arrange the dragged and dropped column element (step S112), determine if the column belonging to the table B in the selected combination is the dragged and dropped column element (step S113), and if not, automatically arrange the relevant column element (step S114).

Subsequently, connect the elements corresponding to the both columns in the selected combination by an interconnect line for association (step S115), and store the information of column elements connected by the interconnect line for association as the association information between elements of the integration metadata (step S116).

Thus, the associating unit 150 extracts and displays combination candidates of columns that can be associated with each other based on the data type, and when there is the existing association in the combination candidates, highlights the candidate, thereby facilitating the associating work by the creator of integration metadata.

The integration reference server 20 stores the existing association information in the following procedure, and provides the information as required. At first, the integration reference server 20 performs actual query by using the created integration metadata, and when the query result is sent back, the integration reference server 20 extracts the association information defined in the integration metadata.

The integration reference server 20 then unifies the extracted association information for each column, and stores the information, designating the information for identifying the column (name or ID of database, table, and column, or both of those names and IDs) as a key, and the information for identifying the column to be associated therewith as a value.

When there is a request for the association information by using the information for identifying the column as a key, the integration reference server 20 extracts a value corresponding to the key, and returns it as the existing association information relating to the specified column.

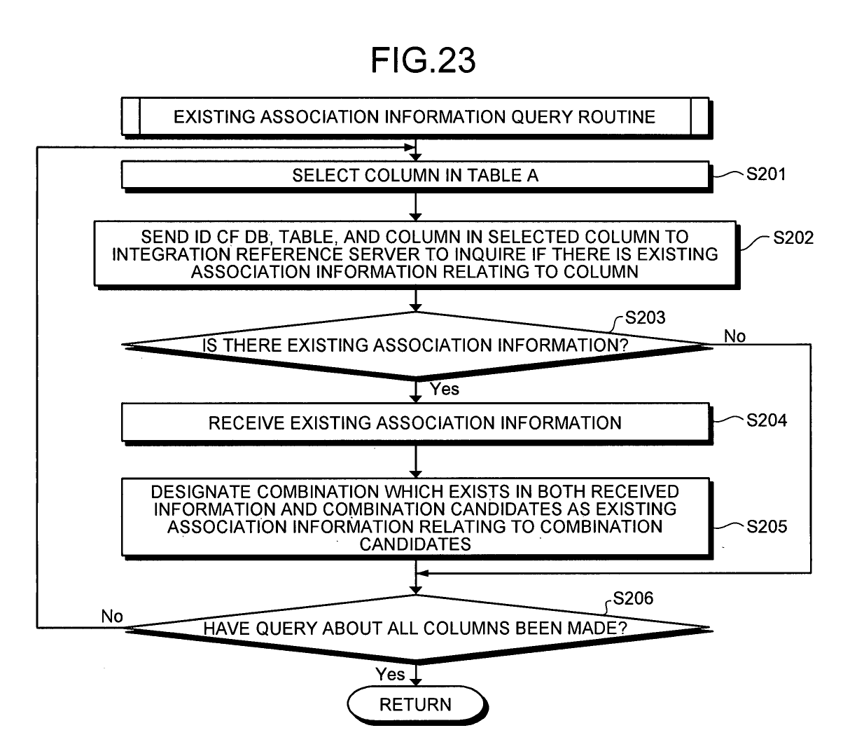

The processing procedure in the existing association information query routine will be explained below. FIG. 23 is a flowchart of the processing procedure in the existing association information query routine. In the existing association information query routine, one column in the table A in the combination candidates is selected (step S201), and the ID of the DB, table, and column of the selected column are sent to the integration reference server 20, to query if there is the existing association information (step S202) relating to the column.

As a result, when the integration reference server 20 replies that there is the existing association information (“YES” at step S203), the existing association information is sent from the integration reference server 20 (step S204), and the combination which exists in both the sent information and the combination candidates is designated as the existing association information relating to the combination candidates (step S205).

It is then determined if query about all columns in the table A in the combination candidates have been made (step S206), and if not, control returns to step S201 to select the next column. If the query about all columns has been made, the processing finishes.

In this manner, in the existing association information query routine, since the integration reference server 20 is referred to about the existing association information, to confirm the existing association information in the combination candidates, proven association is shown, thereby facilitating the associating work of the creator of integration metadata.

The details of the association check processing by the association checking unit 160 will be explained. The association checking unit 160 checks if the association is appropriate, when the association is specified during editing the integration metadata.

When the association is specified, since the records in the specified both tables are joined, at the time of providing the integrated data, the columns in the both tables specified by the association should have a set of the same value. If the both columns have separate values, joining is not possible in the process of creating the integrated data, and hence there is no corresponding integrated data, thereby making the integration metadata meaningless. Therefore, the association check processing by the association checking unit 160 is very important.

Specifically, the association checking unit 160 samples actual data from the specified both tables, statistically analyzes the sampled data, to check if the values of the both columns are associated with each other.

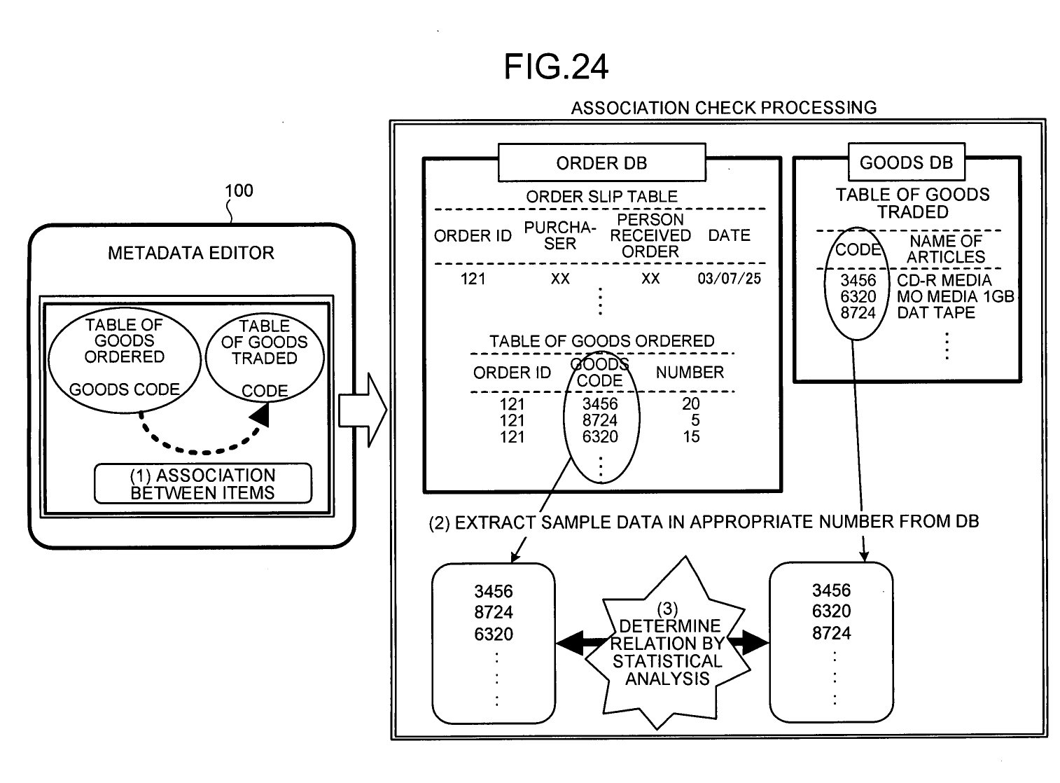

FIG. 24 is a diagram for explaining the outline of the association check processing. FIG. 24 depicts the association check processing when a goods code in a table of goods ordered is associated with a code in a table of goods traded. The association checking unit 160 samples actual data from the goods code in the table of goods ordered and the code in the table of goods traded, and determines the relation between the sampled data by statistical analysis, to check the association.

If the association check is simply executed, it is only necessary to check if data sampled from one of the tables is included in the other table, and determine the association from the percentage. However, with this simple method, there may be the following problems.

Matching by chance: For example, when the data type of the both columns is double figures, and the number of data is large, there may be all of 100 kinds of values of from 00 to 99, and in this case, data may match with each other by chance (without having a meaningful relation).

Fluctuation in the number of samples due to redundancy: For example, even if 100 data are sampled from 10000 data, if there are many redundant data therein, and actually there are only ten types of data, comparison is carried out between data to be associated with each other only by the ten types of data, thereby increasing the probability of being included by chance. As the number of data excluding the redundancy from the sample data decreases, the probability increases.

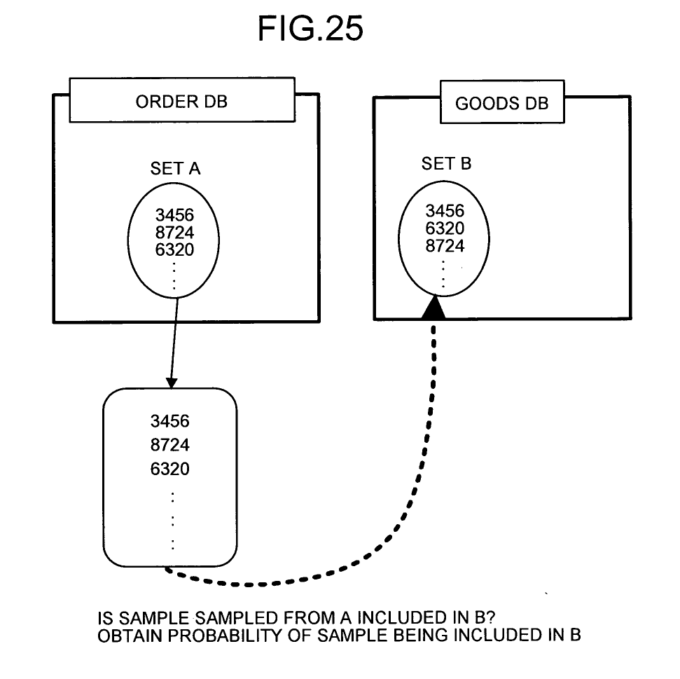

Therefore, the association checking unit 160 checks the association by the following procedure. At first, as shown in FIG. 25, the association checking unit 160 samples a certain number of data from a set A, to check if the sampled individual data is included in a set B, to determine the percentage.

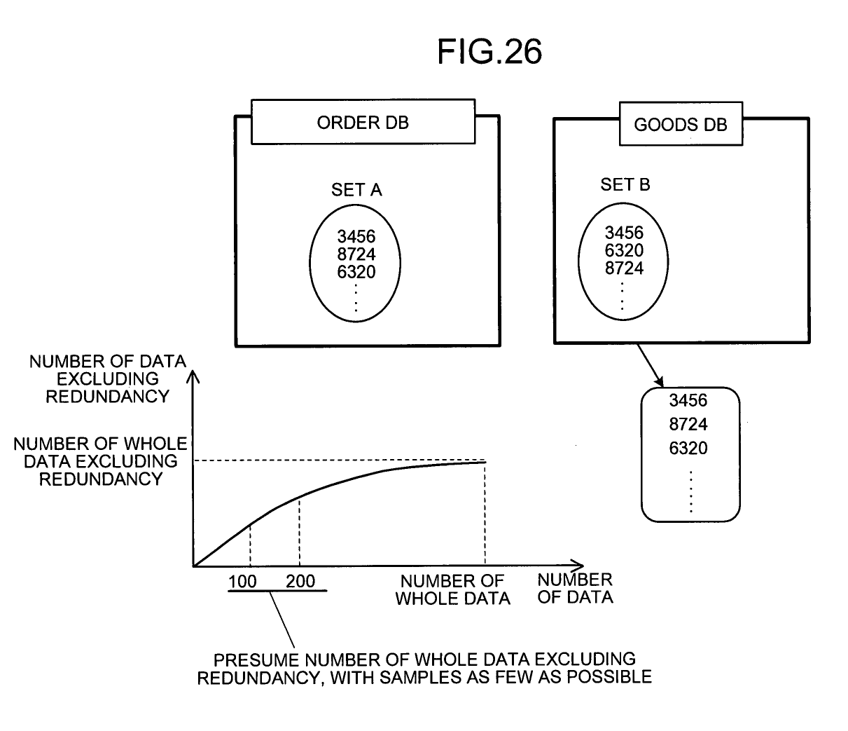

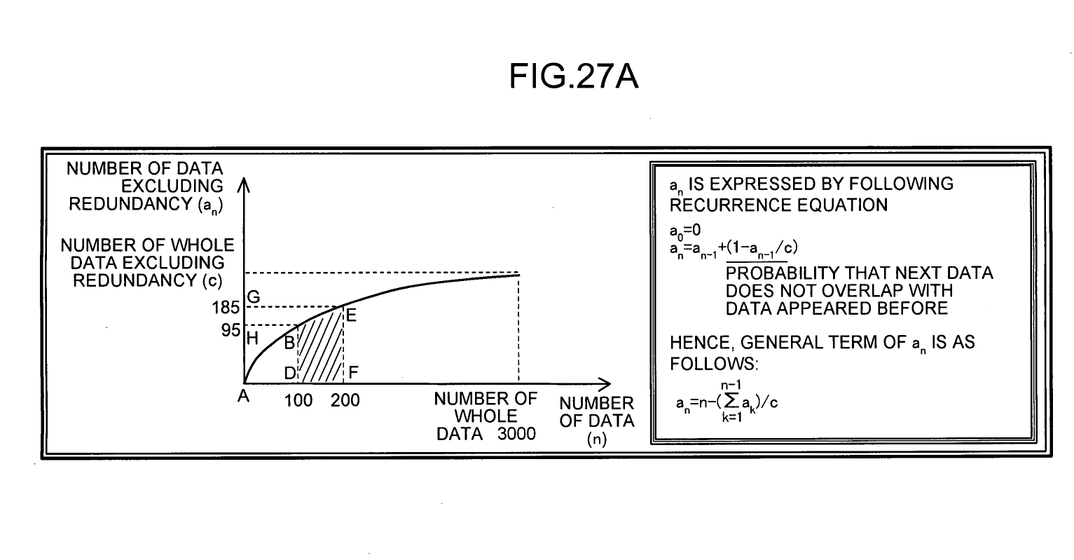

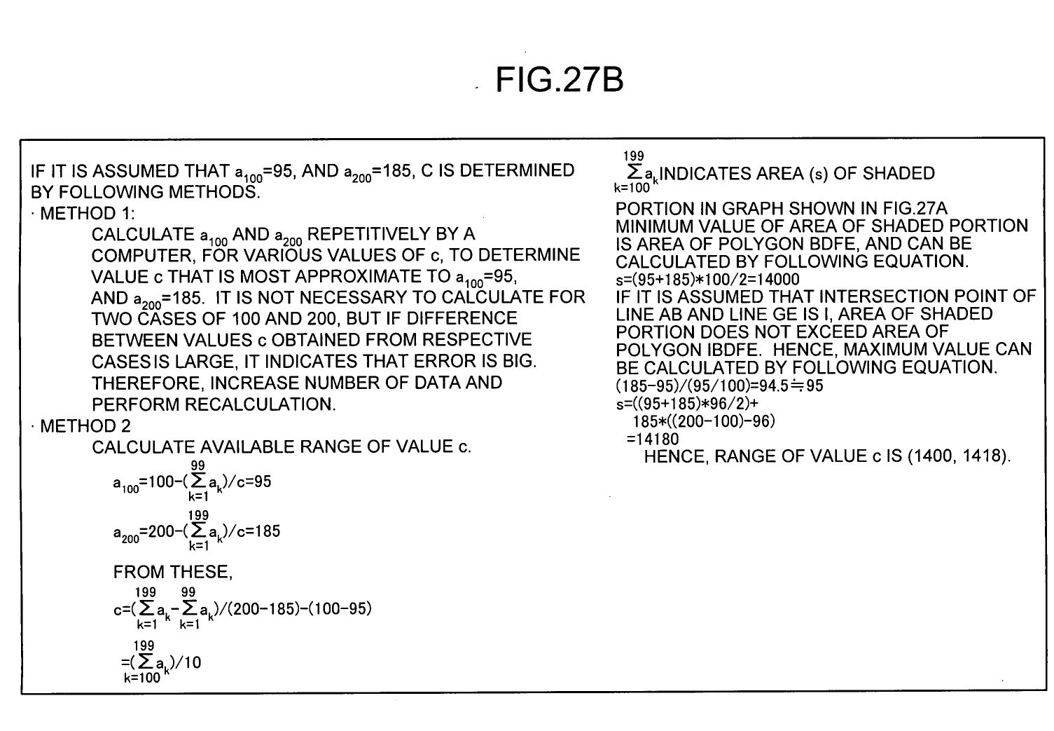

The association checking unit 160 then samples an appropriate number of data from the set B, to count the number of data excluding the redundancy. The association checking unit 160 performs this operation several times, by increasing the number of samples stepwise. As shown in FIG. 26, the number of data excluding the redundancy at the time of sampling a certain number of samples can be expressed by a certain recurrence equation. The association checking unit 160 presumes the number of data excluding the redundancy at the time of sampling of the whole data, that is, the number of whole data excluding the redundancy, from the recurrence equation. The reason why the number of whole data excluding the redundancy is presumed is that sampling of the whole data is unrealistic in view of the performance of the network, and it is necessary to presume the number of whole data excluding the redundancy with the number of samples as few as possible. The recurrence equation used for the presumption of the number of whole data excluding the redundancy includes, as shown in FIG. 27B, a method of determining the optimum value by repetitive calculation by a computer, and a method of determining the range of the value that can be taken. When the column in the set B is added with a unique constraint, since there is no redundant data, the number of whole data is the number of whole data excluding redundancy. Therefore, the presumption of the number of whole data excluding redundancy is not necessary.

The density of the set B (data coverage) is presumed from the number of data in the set B, excluding the redundancy.

Here, density of B=number of data in B excluding redundancy/size of the set,
size of the set=type of data in one digit ˆ number of digits, and
the density of B represents the probability of the data sampled from A being included in B by chance.

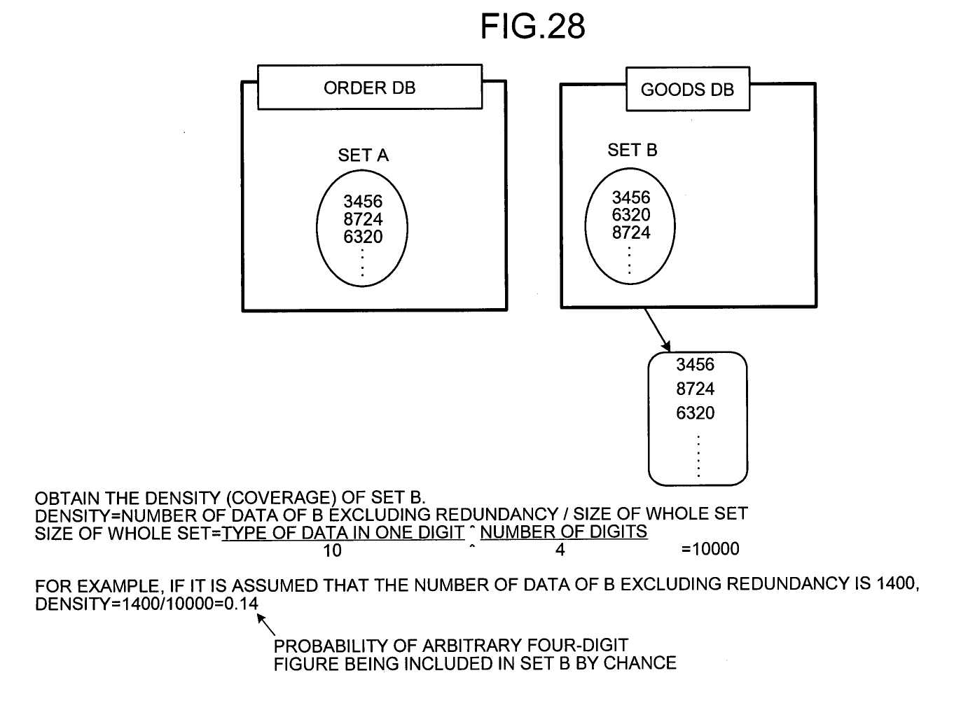

For example, when the data has a four-digit numerical value, such as the sets A and B shown in FIG. 28, the type of data in one digit is ten types of from 0 to 9, and since there are four digits, the size of the whole set becomes the fourth power of 10, that is, 10,000. In other words, the set B has a possibility of including the values of 10,000 at maximum. Actually, however, when the number of whole data in the set B is less than 10,000 or includes redundancy, the number of data in the set B excluding the redundancy becomes lower than 10,000. The ratio is the density of the set B, that is, the probability of an optional four-digit numerical value being included in the set B. In FIG. 28, 0.14 indicates the density of B.

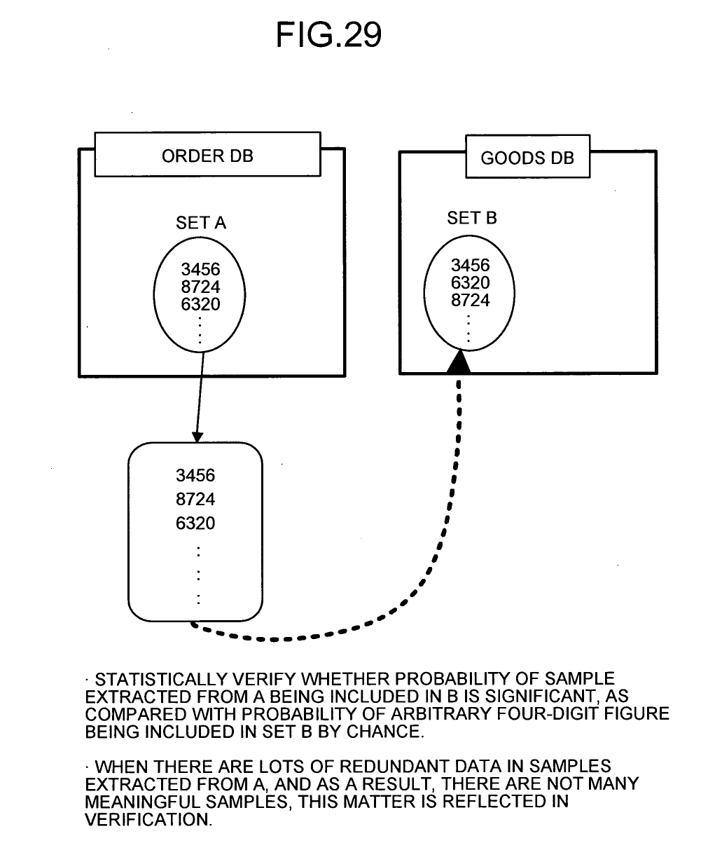

As shown in FIG. 29, the ratio of the sample extracted from A being included in B is compared with the density of B, to check if these do not have an association statistically. By displaying the checking result, the creator of integration metadata can recognize if the specified association is appropriate.

In the embodiment, the association checking is carried out when the creator of integration metadata specified the association. Likewise, the creator of integration metadata can perform checking collectively, at the timing when the creator of integration metadata finishes creation of one integration metadata.

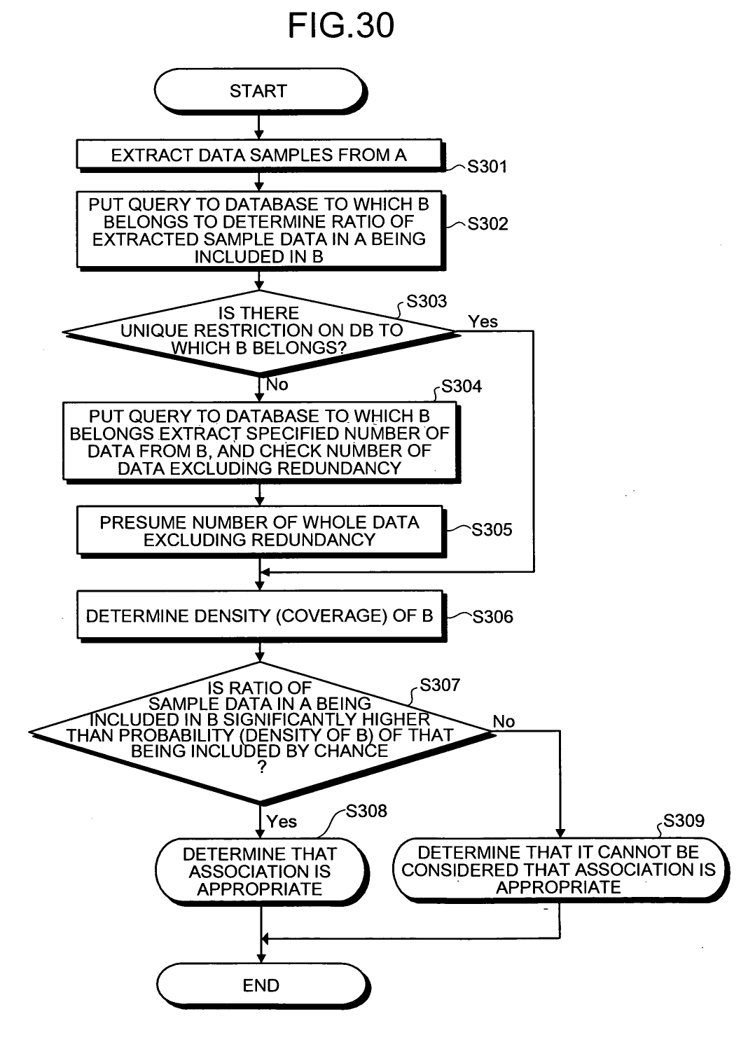

The processing procedure in the association check processing by the association checking unit 160 will be explained with reference to a flowchart. FIG. 30 is a flowchart of the processing procedure in the association check processing by the association checking unit 160.

The association checking unit 160 extracts data samples from A (step S301), and inputs a query to the database to which B belongs via the integration reference server 20, to determine the ratio of the extracted sample data in A being included in B (step S302).

On the other hand, the association checking unit 160 checks if there is a unique constraint in B (step S303), and when there is no unique constraint in B, inputs a query to the database to which B belongs via the integration reference server 20, and samples a specified number of data from B, to check the number excluding the redundancy (step S304). The association checking unit 160 then presumes the number of whole data in B excluding the redundancy (step S305), to determine the density of B (step S306). When there is the unique constraint in B, the association checking unit 160 determines the density of B, by using the whole data in B (step S306).

The association checking unit 160 then determines whether the ratio of the sample data in A being included in B is significant, as compared with the density of B (step S307), and when the ratio is significant, determines that the association is appropriate (step S308), and when the ratio is not significant, determines that it cannot be considered that the association is appropriate (step S309).

Thus, by determining whether the ratio of the sample data in A being included in B is significant as compared with the density of B, to determine the appropriateness of association, the metadata editor 100 can display the appropriateness of association with respect to the creator of integration metadata.

The consistency check of the integration metadata by the consistency checking unit 170 will be explained next. When the database to be integrated is changed, it is necessary to change the integration metadata. The tree structure is created by using only the data available at the time of creation (availability flag=true). On the other hand, when contents of the database are changed, the availability flag for the data is changed to false. Even when only the name is changed, the availability flag for the data before the name change is changed to false, and the data after the name has been changed is registered as new data (availability flag=true).

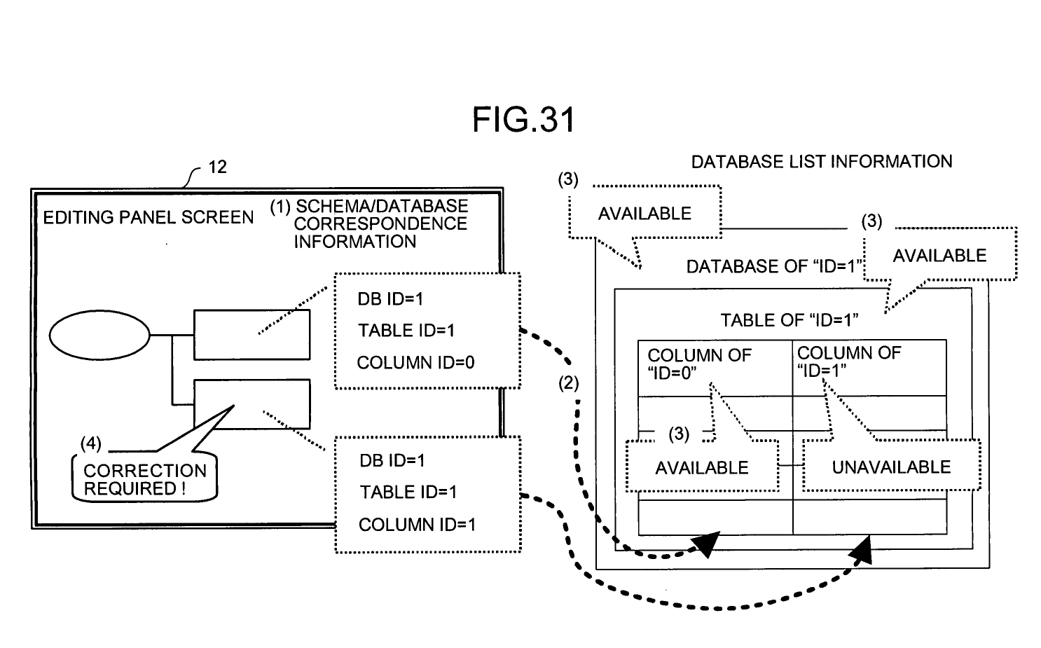

The consistency checking unit 170 checks the consistency by comparing the tree structure and the database list information, and if there is a point having contradiction, displays that the point is to be corrected. The procedure will be explained below with reference to FIG. 31.

Regarding a column element in the tree structure, information corresponding to the column is searched from the database list information, based on the schema/database correspondence information (FIG. 31 (1)) of the integration metadata (FIG. 31 (2)).

From the extracted information, the availability flags of the column, the table including the column, and the database including the table are checked (FIG. 31 (3)). As a result, if all the availability flags indicate being available, the consistency checking unit 170 determines that the column element in the tree structure does not require correction. On the other hand, if any of the availability flags indicates being unavailable, the consistency checking unit 170 determines that the column element in the tree structure requires correction.

The consistency checking unit 170 performs such an operation with respect to all column elements in the tree structure, and displays that correction is necessary to the column element, which is determined to require correction (FIG. 31 (4)). When the corresponding part in the tree structure on the editing panel screen 12 is corrected by the creator of integration metadata, the consistency checking unit 170 updates all of the virtual XML schema information, the schema/database correspondence information, and the association information between elements in the integration metadata. Therefore, the creator of integration metadata only needs to correct the corresponding part in the tree structure on the editing panel, based on the displayed information.

Thus, the consistency checking unit 170 determines the availability of all column elements in the tree structure, and if not available, displays that the column element needs correction. As a result, the creator of integration metadata can easily correct the integration metadata that is not consistent with the database.

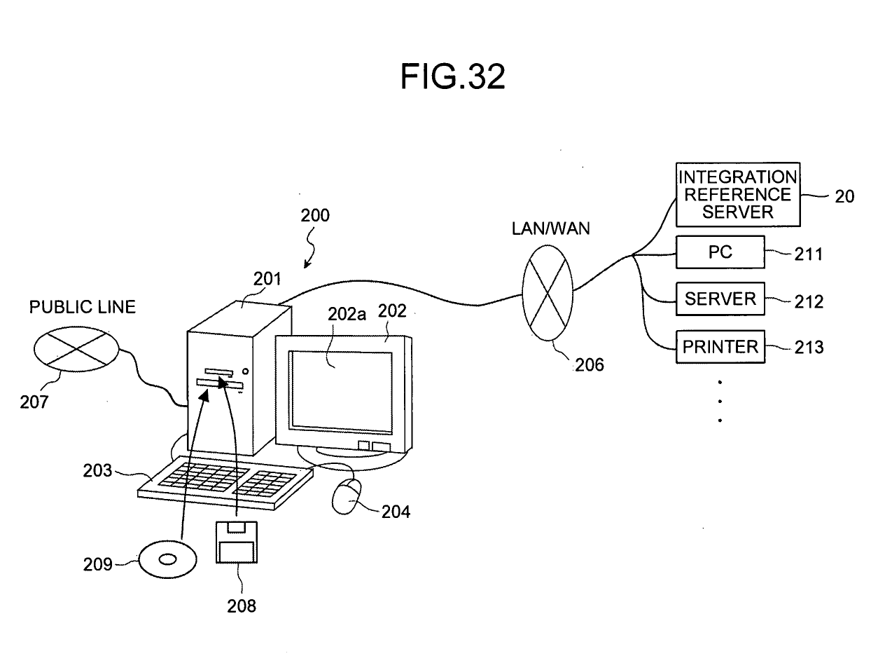

A computer system that executes the metadata editor according to the embodiment will be explained next. FIG. 32 depicts a computer system that executes the metadata editor according to the embodiment.

As shown in FIG. 32, the computer system 200 includes a main unit 201, a display 202 that displays information on a display screen 202a according to an instruction from the main unit 201, a keyboard 203 for inputting various kinds of information to the computer system 200, a mouse 204 for specifying an optional position on the display screen 202a of the display 202, a local are network (LAN) interface for the connection with a LAN 206 or a wide area network (WAN), and a modem for the connection with a public line 207.

The LAN 206 here connects the computer system 200 to the integration reference server 20, other computer systems (PC) 211, a server 212, and a printer 213.

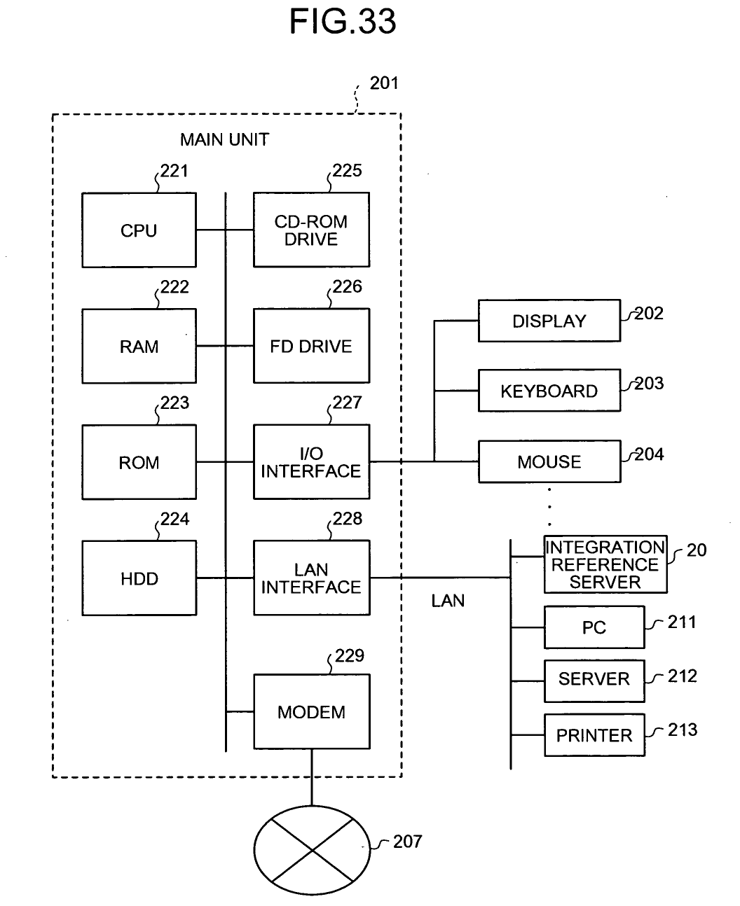

FIG. 33 is a functional block diagram of the configuration of the main unit 201 shown in FIG. 32. The main unit 201 has a central processing unit (CPU) 221, a random access memory (RAM) 222, a read only memory (ROM) 223, a hard disk drive (HDD) 224, a CD-ROM drive 225, a floppy disk (FD) drive 226, an I/O interface 227, a LAN interface 228, and a modem 229.

The metadata editor 100 executed by the computer system 200 is stored in a portable recording medium such as an FD 208, a CD-ROM 209, a digital versatile disk (DVD), a magneto-optical disk, or an IC card, read from the recording medium, and installed to the computer system 200.

Alternatively, the metadata editor 100 is stored in the database in the integration reference server 20 or the server 212, and the database of other PC 211 connected to the computer system 200 via the LAN interface 228, read from these databases, and installed to the computer system 200 as a plug-in program of a browser.

The installed metadata editor 100 is stored in the HDD 224, and executed by the CPU 221 by using the RAM 222 and the ROM 223.

As described above, in the embodiment, the editing processor 140 edits the information of the integration metadata corresponding to the drag and drop operation performed by the creator of integration metadata using the DB-information panel screen 11 and the editing panel screen 12, and when the association between columns becomes possible, the associating unit 150 displays combination candidates for association. When the creator of integration metadata specifies the association combination, the association checking unit 160 statistically determines the validity of the association and displays the validity. When the integration metadata does not correspond with the database, the consistency checking unit 170 displays that correction is necessary with respect to the column element requiring correction. As a result, the creator of integration metadata can create the integration metadata efficiently.

In the embodiment, an example in which the metadata editor 100 transmits the information of integration metadata to the integration reference server 20, the integration reference server 20 converts the integration metadata to the XML format and stores the integration metadata in the metadata storage repository 21 has been explained, but the present invention is not limited thereto. For example, the present invention is also applicable to an instance in which the metadata editor 100 converts the integration metadata information to the integration metadata in the XML format and transmits the integration metadata to the integration reference server 20.

While in the embodiment, an example in which the metadata editor 100 is operated by the client 10 has been explained, the present invention is not limited thereto. For example, the present invention is also applicable to an instance in which the metadata editor 100 is operated by the integration reference server 20.

In the embodiment, an example in which the metadata editor 100 obtains schema information of the database via the integration reference server 20 has been explained, but the present invention is not limited thereto. For example, the present invention is also applicable to an instance in which the metadata editor 100 directly obtains the schema information of the database.

According to the present invention, integration metadata can be created efficiently.

Moreover, according to the present invention, even a creator of the integration metadata who is not familiar with a description rule can create accurate integration metadata.

Furthermore, according to the present invention, the integration metadata can be created by using only accessible data, thereby making it possible to limit data referring persons who can use a view defined by the integration metadata.

Moreover, according to the present invention, it is possible to considerably reduce work of individually checking meta-information of each of the databases. It is also possible for the creator to recognize whether defined association is correct.

Furthermore, according to the present invention, modification made in the databases can be easily recognized, and time and labor for searching a point to be corrected in the metadata can be omitted.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores a computer program for editing metadata that is used for integration of data in a database-integration reference apparatus that refers to data distributed in a plurality of databases virtually as data in a single integrated database, the computer program making a computer execute:
displaying a schema of the databases, the schema being formed with a plurality of elements;
editing the metadata based on an element that is selected by a creator of the metadata from among the elements in the schema, the element being arranged in a tree structure; and
transmitting the metadata edited to the database-integration reference apparatus.

2. The computer readable recording medium according to claim 1, wherein
the database is a relational database, and
the elements are columns in the relational database.

3. The computer readable recording medium according to claim 1, wherein
the elements are displayed on a screen, and
the element is arranged in the tree structure by drag and drop of the element selected from the elements in the schema displayed on the screen into an editing screen for the metadata.

4. The computer readable recording medium according to claim 1, wherein displaying includes displaying the schema within a range for which the creator possesses an access right.

5. The computer readable recording medium according to claim 2, wherein
the metadata includes a first table, and
when other columns in a second table that is different from the first table are added to the metadata, the editing includes displaying a combination candidate of the columns that can be associated with each other.

6. The computer readable recording medium according to claim 5, wherein when there is an old combination candidate of columns that have been associated in the metadata created before, the editing includes providing information on the old combination candidate.

7. The computer readable recording medium according to claim 5, wherein the combination candidate is formed with columns in which all data types are identical.

8. The computer readable recording medium according to claim 1, wherein when an association between different elements is specified, the editing includes determining whether the association is correct and displaying the determined result.

9. The computer readable recording medium according to claim 8, wherein the editing further includes determining whether the association is correct by statistically analyzing a relation between actual data of the different elements for which the association is specified.

10. The computer readable recording medium according to claim 9, wherein the editing further includes determining whether the association is correct based on significance of a probability that the actual data of one of the different elements is included in the actual data of other of the different elements.

11. The computer readable recording medium according to claim 10, wherein
the editing further includes
sampling the actual data of the one of the different elements;
calculating the probability that the actual data sampled is included in the actual data of the other of the different elements;
calculating a density of a set of a value range of the other of the different elements; and
determining whether the probability is valid based on values of the probability and the density.

12. The computer readable recording medium according to claim 1, wherein when a modification is made in the schema, the editing includes providing information that indicates that a part of the metadata corresponding to the modification is to be corrected.

13. The computer readable recording medium according to claim 12, wherein when the metadata that is to be edited is old metadata that is created before, the editing includes determining whether the modification is made in the schema that is used for creating the old metadata.

14. A computer-readable recording medium that stores a computer program for editing metadata that is used when data distributed in a plurality of databases is to be referenced virtually as data in a single integrated database, the computer program making a computer execute:
displaying a schema of the databases, the schema being formed with a plurality of elements;
editing the metadata based on an element that is selected by a creator of the metadata from among the elements in the schema, the element being arranged in a tree structure; and
storing the metadata edited in a storage unit.

15. The computer readable recording medium according to claim 14, wherein the metadata is stored in an Extensible Markup Language format.

16. The computer readable recording medium according to claim 14, further making the computer execute monitoring the databases to obtain information on the schema from the databases at a predetermined time interval, wherein
the schema is displayed using the information obtained.

17. The computer readable recording medium according to claim 16, wherein
the monitoring includes obtaining the information within a range for which the creator possesses an access right with respect to each of the databases, and
the displaying includes displaying the schema within the range.

18. A method for editing metadata that is used for integration of data in a database-integration reference apparatus that refers to data distributed in a plurality of databases virtually as data in a single integrated database, the method comprising:
displaying a schema of the databases, the schema being formed with a plurality of elements;
editing the metadata based on an element that is selected by a creator of the metadata from among the elements in the schema, the element being arranged in a tree structure; and
transmitting the metadata edited to the database-integration reference apparatus.

19. An apparatus for editing metadata that is used for integration of data in a database-integration reference apparatus that refers to data distributed in a plurality of databases virtually as data in a single integrated database, the apparatus comprising:
a display unit that displays a schema of the databases, the schema being formed with a plurality of elements;
an editing unit that edits the metadata based on an element that is selected by a creator of the metadata from among the elements in the schema, the element being arranged in a tree structure; and
a transmitting unit that transmits the metadata edited to the database-integration reference apparatus.
